(19) United States
(12) Patent Application Publication
(10) Pub. No.: US 2025/0047622 A1
(43) Pub. Date: Feb. 6, 2025

(54) GENERATING DIVERSE MESSAGE CONTENT SUGGESTIONS

(71) Applicant: Microsoft Technology Licensing, LLC, Redmond, WA (US)

(72) Inventors: Praveen Kumar Bodigutla, San Jose, CA (US); Sai Krishna Bollam, Union City, CA (US); Saurabh Gupta, Bellevue, WA (US)

(21) Appl. No.: 18/487,408

(22) Filed: Oct. 16, 2023

Related U.S. Application Data
(60) Provisional application No. 63/517,867, filed on Aug. 4, 2023.

(51) Int. Cl. H04L 51/02; G06F 40/56; H04L 51/04

(52) U.S. Cl. CPC H04L 51/02; G06F 16/334; G06F 16/35; G06F 40/56; H04L 51/04

(57) ABSTRACT

Embodiments of the disclosed technologies are capable of generating diverse suggested message content. The embodiments describe generating a message plan comprising attribute data and section data. The embodiments further describe inputting the message plan as a prompt to a first generative model. The first generative model is fine-tuned using a training message plan. The training message plan comprises an ordered sequence of training attribute data and training section data. The training attribute data and training section data are extracted from historic messages or generated messages. The embodiments further describe generating, by the first generative model, message content suggestions based on the attribute data and section data.

### CROSS-REFERENCE TO RELATED APPLICATION

The present application claims the benefit under 35 U.S.C. § 119 (e) of U.S. Provisional Patent Application Ser. No. 63/517,867, filed Aug. 4, 2023 which is incorporated herein by this reference in its entirety.

### TECHNICAL FIELD

A technical field to which the present disclosure relates is the generation of digital content, such as electronic messages. Another technical field to which the present disclosure relates is automated content generation using artificial intelligence.

### BACKGROUND

Messaging systems are computer systems that use computer networks to transmit electronic messages between or among user accounts via computing devices. For example, an electronic message is composed by a sender using the sender's account at the sender's computing device. The sender identifies one or more prospective recipients of the message, and the messaging system transmits the message to the accounts of the one or more prospective recipients.

There are many different types of messaging systems. Electronic mail (email) is a form of electronic messaging. Instant messaging, text messaging, direct messaging, in-app messaging, mobile messaging, multimedia messaging, and push notifications are forms of messaging systems that typically have fewer features than email and are often useful for short asynchronous or real-time conversations between or among users.

In-app messaging differs from email and text messaging in that, whereas a sender can attempt to send emails and text messages to any recipient as long as the recipient's handle or address is known, the prospective recipients of in-app messaging are limited to the app's user base.

Some forms of in-app messaging are public. For example, some application software systems, such as social network services and some asynchronous messaging systems, allow their users to message each other in a way that makes the messages available for viewing by other users of those systems. Direct messaging systems provide a non-public mode of electronic communication between or among users of an application software system. In direct messaging, only the sender and the recipient can see the messages exchanged between them.

Some social network-based applications further restrict direct messaging. For example, in some applications, the ability to send direct messages is limited to the sender's connections. That is, the sender can only direct message recipients with whom the sender is connected by the social network. An application may grant a sender broader access to a larger group of potential direct message recipients if the sender's user account satisfies one or more applicable criteria. For example, a sender may be granted broader access if the sender has not had any policy violations while using the application or if the sender's role qualifies the sender for broader access (e.g., if the sender is a premium user or a recruiter).

Internet-based software applications can have millions or hundreds of millions of users worldwide. In these cases, messaging systems facilitate the distribution of electronic messages between or among the app users on a very large scale. For example, messaging systems can distribute millions of messages to hundreds of millions of user devices worldwide, every day. The messages can include various different forms of digital content, including text, images, audio, and/or video content.

### BRIEF DESCRIPTION OF THE DRAWINGS

The invention may best be understood by referring to the following description and accompanying drawings that are used to illustrate embodiments of the invention. In the drawings:

FIG. 1 is a flow diagram of an example method for automated message suggestion generation using components of a generative message suggestion system in accordance with some embodiments of the present disclosure.

FIG. 2 illustrates an example of a user interface, in accordance with some embodiments of the present disclosure.

FIG. 3 is an example flow diagram of an example method for training one or more machine learning models, in accordance with some embodiments of the present disclosure.

FIG. 4 is a flow diagram of an example method for generating content, in accordance with some embodiments of the present disclosure.

FIG. 5 is a flow diagram of an example method for training a section classifier using supervised learning, in accordance with some embodiments of the present disclosure.

FIG. 6 is a flow diagram of an example method for generating a training message plan, in accordance with some embodiments of the present disclosure.

FIG. 7 is a flow diagram of an example method for training a language model using a plan-based fine-tuning framework, in accordance with some embodiments of the present disclosure.

FIG. 8 is a flow diagram of an example method of the inputs and outputs of a language model, in accordance with some embodiments of the present disclosure.

FIG. 9 is an example of a model plan generated using constrained plan of action (cPoA) to instruct a machine learning model to generate suggested message content, in accordance with some embodiments of the present disclosure.

FIG. 10 is a block diagram of a computing system that includes a generative message suggestion system in accordance with some embodiments of the present disclosure.

FIG. 11 is an example of an entity graph in accordance with some embodiments of the present disclosure.

FIG. 12 is a flow diagram of an example method for fine tuning a machine learning model, in accordance with some embodiments of the present disclosure.

FIG. 13 is a block diagram of an example computer system including a training manager component, in accordance with some embodiments of the present disclosure.

### DETAILED DESCRIPTION

When a sender of an electronic message sends the message to a prospective recipient, the message may be at least temporarily stored in a message inbox at the prospective recipient's account, but the sender has no guarantee that the message will be accepted by the prospective recipient. Thus, as used herein, prospective recipient may refer to a user to whom a sender has sent an electronic message but who has not yet accepted the message, while recipient may refer to a prospective recipient that has accepted the message. Recipient or prospective recipient may refer to one or more users who are the target of a sender's message. For example, the sender may address their message to one or more prospective recipients, and some or all of the prospective recipients may accept the message.

Accepted as used herein may refer to any action or series of actions by the prospective recipient that indicate message acceptance, including clicking or tapping on a message icon related to a message, opening a message, viewing a message, reading a message, replying to a message, etc. In contrast, actions that indicate a lack of message acceptance include explicitly rejecting a message, declining receipt of a message, ignoring a message, deleting a message, moving a message to a ‘junk’ folder, reporting a message as spam, or allowing a message to remain unopened or unread for an extended period of time.

Acceptance data, which indicates whether or not a sender's message has been accepted, can be logged and tracked, for example by a logging service or an analytics component of the messaging system. In some implementations, acceptance may refer to the occurrence of a specific user interface event. For example, acceptance can occur when the recipient of a message takes a specific action such as clicking on a “Yes, interested” button on the messaging interface to explicitly indicate that the recipient is interested in the topic or opportunity represented by the message. Alternative or in addition, acceptance can occur implicitly when the recipient of a message responds to the message by typing any typed free text that the system interprets as an acceptance. For example, an artificial intelligence model trained to classify sequences of clicks and/or keystrokes as an acceptance or not an acceptance (e.g., a binary classifier or other machine learning model), can be used to detect implicit acceptance.

The acceptance data can be used to compute the sender's acceptance rate. Acceptance rate as used herein may refer to a computation based on historical data that reflects a comparison of the number of the sender's messages that have been accepted in a specific time period to the total number of messages sent by the sender in that same time period. Acceptance rate can be computed for individual senders or in the aggregate for groups of senders, where a group of senders has at least one common characteristic. Acceptance rate also can be computed for various combinations of recipients and prospective recipients. For example, a sender can have different acceptance rates for different recipient groups, where a group of recipients has at least one common characteristic. Senders can use acceptance rate to measure the success of their previous messaging efforts.

Historical acceptance rate data can be used to compute an acceptance probability. Acceptance probability as used herein may refer to a computed (e.g., probabilistic or statistical) likelihood of a particular message created and sent by a particular sender being accepted by a particular prospective message recipient. Acceptance probability can be used to predict, e.g., before a message is sent, a likelihood that the message the sender is composing will be accepted by the prospective recipient.

Composing a message that has a high acceptance probability can be challenging for many message senders. Finding the right words and organizing them in an appealing way based on the needs, interests, or preferences of a particular prospective recipient can be very time consuming as well. Further, many message senders may be unaware of the message components and/or message writing techniques that can lead to a high likelihood of acceptance. These barriers to effective message composition can be exacerbated by the limitations of conventional user input devices. For example, smaller form factor touch-based keypads and touchscreens make typing error prone and conventional auto-correct mechanisms are often inaccurate. Speech-based input mechanisms can facilitate the input of message text by enabling the sender to use their voice to input the message content, but conventional speech-to-text and speech-to-image technologies still produce transcription errors that need to be manually corrected using the touchscreen. As a result of these and other limitations of conventional input devices, senders are often required to perform labor-intensive reviews and revisions of the message they create before the message is ready to be sent to the prospective recipient. However, message senders often may not have the time or inclination to perform such reviews and revisions, resulting in sub-optimal acceptance rates for the messages that they send.

Conventional attempts to improve the message creation process have provided generalized message templates. While efficient, these standardized templates are impersonal and have low rates of acceptance. The conventional alternative to generalized templates is for the sender to hand-write personalized messages to each individual prospective recipient or to hand-modify the template for each prospective recipient. Manually writing personalized messages or hand-modifying templates have resulted in higher acceptance rates but the message creation process is not efficient. For high-volume senders, the use of generalized templates is scalable but produces sub-optimal acceptance rates. On the other hand, the manual-personalization approaches produce improved acceptance rates but are not scalable.

There is an abundance of historic messages (e.g., previously sent messages) and message templates that can be used to generate message suggestions. There is also an abundance of metadata associated with such historic messages and message templates such as acceptance probabilities. However, a technical challenge is to determine whether the captured data (such as the historic messages) is diverse in content and representative of different types of successful messages. Another technical challenge includes efficiently capturing the historic messages, generating insights (e.g., determining whether the captured data is diverse, determining the acceptance probability of the historic message), and generating diverse messages with high acceptance probabilities at scale. Yet another technical challenge is developing an automated process for generating message suggestions using generative artificial intelligence. For example, generative artificial intelligence (GAI) can successfully predict text used to perform tasks (e.g., generating message suggestions). However, crafting the prompts used by GAI, as described in more detail below, can be technically challenging. For example, determining what information to include the in prompt (e.g., historic messages with high acceptance probabilities that are diverse and representative of different types of successful messages) and how to convey the information in the prompt is directly related to how the GAI performs its target task. A

To address these and other technical challenges of conventional message creation systems, the disclosed approaches leverage artificial intelligence technologies including generative models to facilitate a generative, collaborative process that can lead to the creation of messages with improved acceptance probability.

A generative model uses artificial intelligence technology, e.g., neural networks, to machine-generate new digital content based on model inputs and the previously existing data with which the model has been trained. Whereas discriminative models are based on conditional probabilities P (y|x), that is, the probability of an output y given an input x (e.g., is this a photo of a dog?), generative models capture joint probabilities P (x, y), that is, the likelihood of x and y occurring together (e.g., given this photo of a dog and an unknown person, what is the likelihood that the person is the dog's owner, Sam?).

A generative language model is a particular type of generative model that generates new text in response to model input. The model input includes a task description, also referred to as a prompt. A prompt can be in the form of natural language text, such as a question or a statement, and can include non-text forms of content, such as digital imagery and/or digital audio. The prompt can include instructions and/or examples of content used to explain the task that the generative model is to perform. Modifying the instructions, examples, content, and/or structure of the prompt causes modifications to the output of the model. For example, changing the instructions included in the prompt causes changes to the generated content determined by the model.

Prompt engineering is a technique used to optimize the structure and/or content of the prompt input to the generative model. Some prompts can include examples of outputs to be generated by the generative model (e.g., few-shot prompts), while other prompts can include no examples of outputs to be generated by the generative model (e.g., zero-shot prompts). Chain of thought prompting is a prompt engineering technique where the prompt includes a request that the model explain reasoning in the output. For example, the generative model performs the task provided in the prompt using intermediate steps where the generative model explains the reasoning as to why it is performing each step.

A large language model (LLM) is a type of generative language model that is trained using an abundance of domain-neutral data (e.g., publicly available data) such that billions of hyperparameters that define the LLM are used to learn a domain-neutral task. Some pretrained LLMs, such as generative pretrained transformers (GPT) can be trained to perform tasks including natural language processing (NLP) tasks such as text extraction, text translation (e.g., from one language to another), text summarization, and text classification.

LLMs are trained to perform tasks by relying on patterns and inferences learned from training data, without requiring explicit instructions to perform the tasks. While pretrained LLMs may be well suited to perform various domain-neutral tasks (e.g., tasks learned using widely available or public data), applying domain-specific data to such LLMs can cause a drop of the LLM's performance. For example, a LLM is less suited to perform text summarization of a domain-specific text if the LLM has not been trained to summarize text using domain-specific language.

Additionally, while the operation of LLMs is stochastic in nature, content generated by the LLM can be homogeneous, monotone, or otherwise not diverse. For example, a masked language model (MLM), an example type of a LLM, learns to predict a word in a sentence based on the context of the sentence. Although the operation of the MLM is stochastic, the optimal best predicted word for the sentence can be the same over a number of iterations. Accordingly, some LLMs generate content that is not diverse. In some cases, LLMs can be trained to generate diverse content. For example, sampling techniques used to decode embeddings can increase the diversity of the generated content. However, in some cases, the generated content, while diverse, is inaccurate and/or irrelevant.

Fine-tuning a pretrained LLM as used herein may refer to a mechanism of adjusting the hyperparameters of the LLM that has been pretrained on domain-neutral data, and then tuning the pretrained LLM to perform a similar task in a domain-specific environment. For example, a LLM trained to perform text summarization using domain-neutral data can be fine-tuned to perform domain-specific text summarization using domain-specific data.

The technologies described herein are capable of generating suggested message content. The suggested messages include machine-generated content that can form or be included in the body of the message. In addition, the suggested messages are customizable based on available information about the sender and/or the prospective recipient which, in some implementations, is obtained using a dynamically-updated entity graph. The suggested messages are further customizable based on user inputs such as sender preferences.

In contrast to the conventional methods for facilitating message creation, the disclosed technologies are both generative and collaborative in that aspects can efficiently produce suggested messages that are automatically customized based on the most currently available information about the sender, the subject of the message, and/or prospective recipient. For example, as opposed to fine-tuning a machine learning model to generate message suggestions in a particular domain (necessitating an abundance of domain-specific training data), components of the disclosed generative message suggestion system retrieve dynamic data (including currently available information about the sender, sender preferences regarding the subject of the message, currently available information about the prospective recipient, and diverse content) using retrieval augmented generation. Retrieving such dynamic data allows the generative message suggestion system to generate up-to-date content and new sections of messages without prior historic message examples that would otherwise be necessary to fine-tune a model in a particular domain. The retrieved information is formatted as a dynamic message plan that is fed to a generative machine learning model such as a language model. This approach facilitates the message composition process and improves the likelihood that the sender will produce a diverse message that will be accepted by the prospective recipient while reducing the need for the sender to engage in lengthy interactions with cumbersome input mechanisms, thereby reducing the time from message creation to transmission to the prospective recipient.

The components of the disclosed generative message suggestion system are configured in a way that makes personalized message suggestion generation scalable. For example, previous attempts at facilitating personalized message creation have not been successful because they were not scalable due to the amount of human labor required to manually customize the message content. In contrast, the disclosed technologies include a machine learning model that generates diverse content, increasing the scalability of the machine learning model as the diverse content can be used to generate messages for larger audiences. Also, the machine learning model is configurable to generate multiple different or alternative message suggestions simultaneously, enabling the user to select from among the message suggestions. When multiple different message suggestions are machine-generated simultaneously for each sender, the number of potential message suggestions can scale quickly to, for example, accommodate highly active users.

Certain aspects of the disclosed technologies are described in the context of generative models that output pieces of writing, i.e., natural language text. However, the disclosed technologies are not limited to uses in connection with text output. For example, aspects of the disclosed technologies can be used to generate message suggestions that include non-text forms of machine-generated output, such as digital imagery, videos, and/or audio.

Certain aspects of the disclosed technologies are described in the context of non-public electronic messages distributed via a user network, user connection network, or application software system, such as a direct messaging feature of a social network service. However, aspects of the disclosed technologies are not limited to direct messaging or to social network services, but can be used to improve the generation of customized electronic messages with other types of software applications. Any network-based application software system can act as user network or application software system to which the disclosed technologies can be applied. For example, news, entertainment, and e-commerce apps installed on mobile devices, enterprise systems, messaging systems, search engines, workflow management systems, collaboration tools, and social graph-based applications can all function as application software systems with which the disclosed technologies can be used.

The disclosure will be understood more fully from the detailed description given below, which references the accompanying drawings. The detailed description of the drawings is for explanation and understanding, and should not be taken to limit the disclosure to the specific embodiments described.

In the drawings and the following description, references may be made to components that have the same name but different reference numbers in different figures. The use of different reference numbers in different figures indicates that the components having the same name can represent the same embodiment or different embodiments of the same component. For example, components with the same name but different reference numbers in different figures can have the same or similar functionality such that a description of one of those components with respect to one drawing can apply to other components with the same name in other drawings, in some embodiments.

Also, in the drawings and the following description, components shown and described in connection with some embodiments can be used with or incorporated into other embodiments. For example, a component illustrated in a certain drawing is not limited to use in connection with the embodiment to which the drawing pertains, but can be used with or incorporated into other embodiments, including embodiments shown in other drawings.

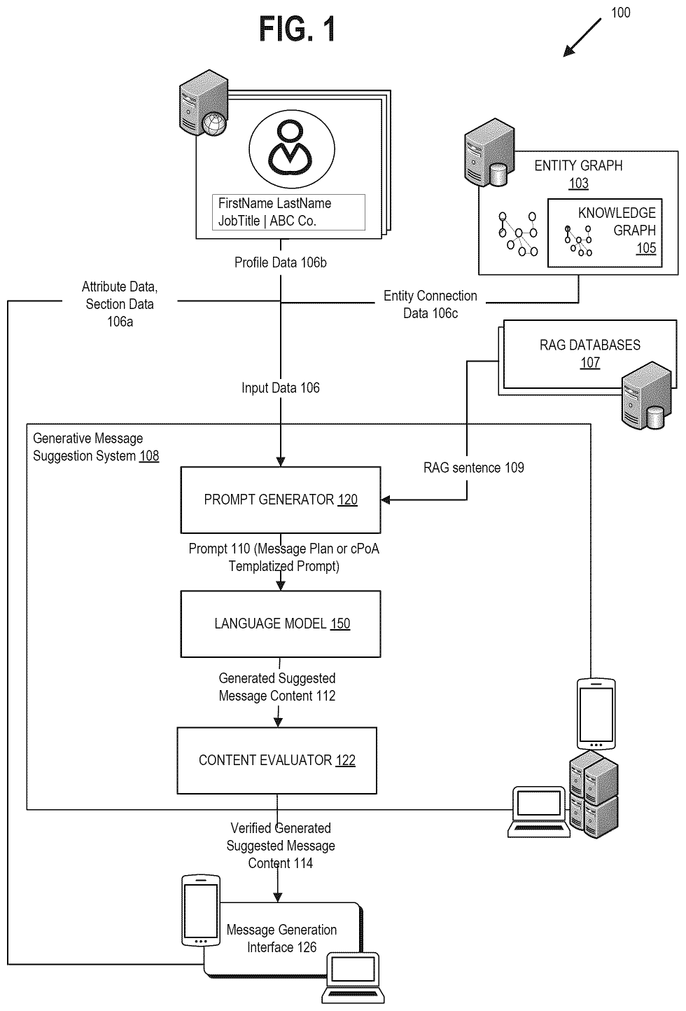

FIG. 1 is a flow diagram of an example method for automated message suggestion generation using components of a generative message suggestion system in accordance with some embodiments of the present disclosure.

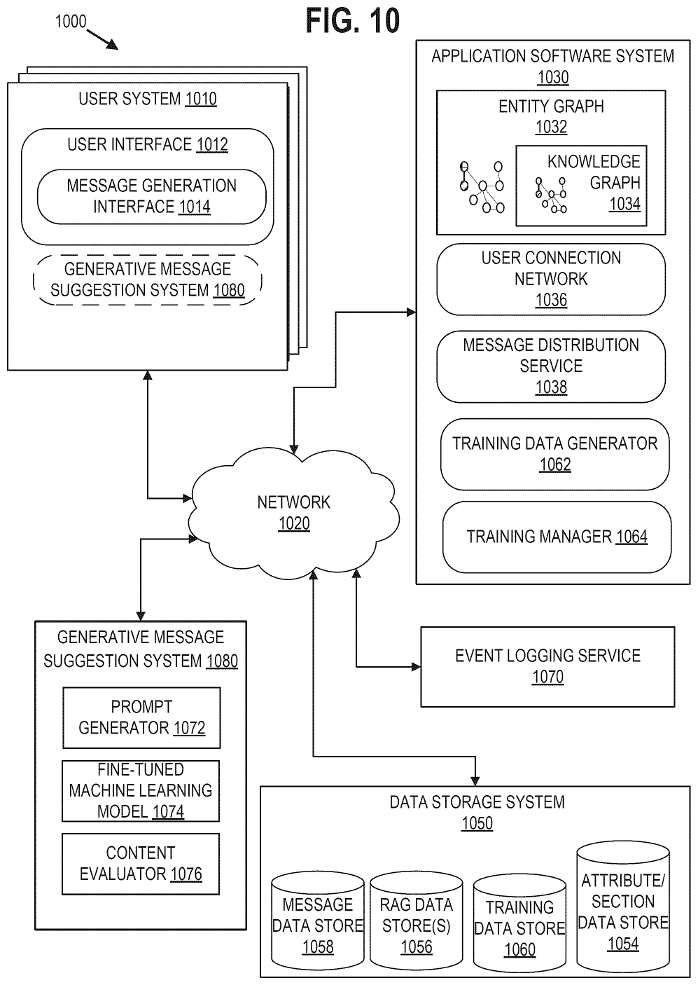

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of generative message suggestion system 1080 of FIG. 10, including, in some embodiments, components shown in FIG. 10 that may not be specifically shown in FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 1, a computing system 100 is shown, which includes a generative message suggestion system 108. The generative message suggestion system 108 of FIG. 1 includes a prompt generator 120 and a language model 150. In the example of FIG. 1, the components of the generative message suggestion system 108 are implemented using an application server or server cluster, which can include a secure environment (e.g., secure enclave, encryption system, etc.) for the processing of message data. The generative message suggestion system 108 is in bidirectional communication with a message generation interface 126 via a network. Message generation interface 126 includes front end user interface functionality that is considered part of generative message suggestion system 108, in some embodiments.

As indicated in FIG. 1, components of computing system 100 are distributed across multiple different computing devices, e.g., one or more client devices, application servers, web servers, and/or database servers, connected via a network, in some implementations. In other implementations, at least some of the components of computing system 100 are implemented on a single computing device such as a client device. For example, some or all of the generative message suggestion system 108 is implemented directly on the user's client device in some implementations, thereby avoiding the need to communicate with servers over a network such as the Internet.

The input data 106 can include attribute data and section data 106a, profile data 106b, and entity connection data 106c. The input data 106 can be provided to generative message suggestion system 108 from a variety of different data sources including user interfaces, databases and other types of data stores, including online, real-time, and/or offline data sources. In the example of FIG. 1, attribute data and section data 106a is received via one or more user devices or systems, such as portable user devices like smartphones, wearable devices, tablet computers, or laptops; profile data 106b is received via one or more web servers; and entity connection data 106c is received via one or more database servers; however, any of the different types of input data 106 can be received by generative message suggestion system 108 via any type of electronic machine, device or system.

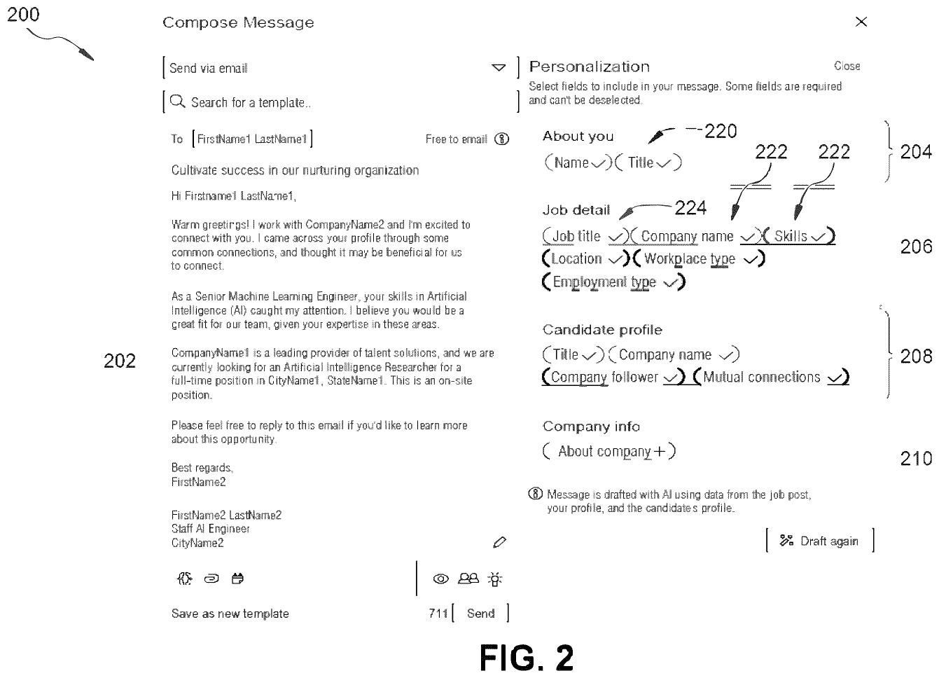

The attribute data and section data 106a are data used to define a message structure (e.g., section data) and semantic content of a message (e.g., attribute data). A section represents common logical segments serving a unique purpose within a message to be generated. An attribute is a feature or characteristic of the sender, prospective recipient, or other content (e.g., an attribute of a job opportunity). The attribute data and section data 106a can be obtained by the generative message suggestion system 108 via a user interface such as message generation interface 126 and/or retrieved from one or more data stores, such as searchable databases that store historical information about the use of the messaging system or application software system operating the messaging system. The attribute data and section data 106a can include structured data, such as data entered by the user into an online form that enforces one or more input rules that constrain the values and/or format of the input, and/or unstructured data, such as natural language text, audio, or transcriptions. FIG. 2 described herein illustrates an example message generation interface 126 used to obtain attribute data and section data 106a.

Examples of profile data 106b include user experience, interests, areas of expertise, educational history, job titles, skills, job history, etc. Profile data 106b can be obtained by the generative message suggestion system 108 by, for example, querying one or more data stores that store entity profile data for the messaging system or application software system operating the messaging system.

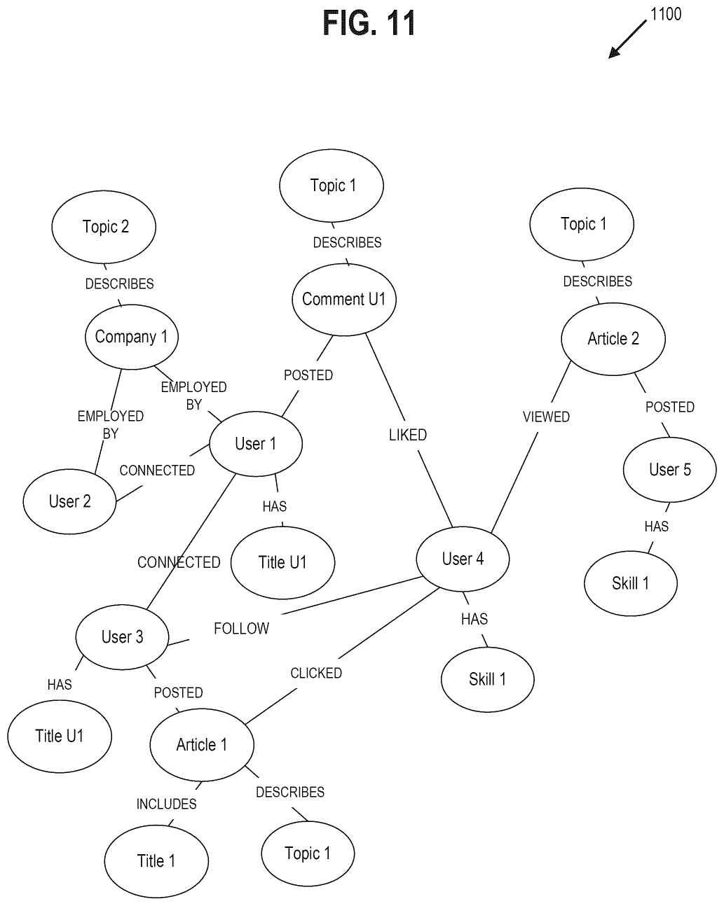

Examples of entity connection data 106c include data extracted from entity graph 103 and/or knowledge graph 105. The entity graph 103 includes entity profile data arranged according to a connection graph, e.g., a graph of connections and relationships between users of the user connection network and between users and other entities. For example, the entity graph 103 represents entities as nodes and relationships between entities as edges between the nodes. In some implementations, entity graph 103 includes a cross-application knowledge graph 105. The cross-application knowledge graph 105 is a subset of the entity graph 103 or a superset of the entity graph 103 (e.g., a combination of multiple entity graphs) that links data from the user connection network with data from other application software systems, such as a user connection network or a search engine. Entity connection data 106c is extracted from an application software system operating the entity graph 103 or knowledge graph 105 by, for example, traversing the entity graph 103 or knowledge graph 105, e.g., by executing one or more queries on one or more data stores that store data associated with the nodes and edges of the entity graph 103 or knowledge graph 105. An example of an entity graph or cross-application knowledge graph is shown in FIG. 11, described herein.

The prompt generator 120 receives the input data 106 and generates prompt 110 for the language model 150. In some embodiments, the generated prompt 110 can include a message plan. Providing only attributes (e.g., prospective recipient attributes, job attributes, sender attributes, and/or entity attributes) to a language model decreases the controlled style and structure of the generated suggested message content, causing the sender to edit the generated suggested message content manually (e.g., inserting paragraph breaks, rearranging the order of the message content, clustering related sentences). Such manual labor reduces the scalability of generated message content. Accordingly, the message plan provides both structural guidance (e.g., sections) and content-specific directives (e.g., attributes). For example, the message plan integrates input data 106 including the prospective recipient data (e.g., profile data 106b of the prospective recipient), the subject of the message (e.g., a job posting), the match between the subject of the message (e.g., job requirements), and the prospective recipient's background (e.g., profile data 106b), and the sender's preferences (based on, e.g., the sender's profile data 106b and/or attribute data and section data 106a) to direct the language model 150 to generate personalized suggested message content specific to a domain. The prompt generator 120 generates the message plan by applying one or more string transformations to the input data 106. For example, received attribute data and section data 106a can be inserted into a prompt by creating an input prompt string. In some embodiments, the prompt generator 120 randomizes the order of the input prompt strings to diversify the generated suggested message content.

The prompt generator 120 can query one or more retrieval augmented generation (RAG) databases 107 for one or more RAG sentences 109 when generating the prompt 110. A RAG sentence 109 is a sentence associated with sections and/or attributes of a message. The sentence is retrieved using retrieval augmented generation (RAG). RAG is used to query external knowledge databases (such as RAG databases 107) to provide content to language models (such as language model 150) in the form of a prompt (determined by prompt generator 120). RAG allows the language model 150 to obtain dynamic content because the external databases storing content can be dynamically updated (e.g., adding RAG sentences 109, modifying RAG sentences 109, removing RAG sentences 109). As a result, the content provided to the language model 150 via prompt 110 can be dynamically updated, without modifications (such as additional training or fine-tuning) to the language model 150.

RAG sentences 109 can be automatically generated by a machine learning model and/or manually created by a user. In some embodiments, multiple RAG databases 107 store RAG sentences 109. For example, a first RAG database 107 stores RAG sentences 109 associated with a first section, and a second RAG database 107 stores RAG sentences 109 associated with a second section. Similarly, a third RAG database 107 stores RAG sentences 109 associated with a first attribute, and a fourth RAG database 107 stores RAG sentences 109 associated with a second attribute. By storing RAG sentences 109 in indexed RAG databases 107, particular RAG sentences 109 can be inserted into a prompt by the prompt generator 120. For example, responsive to a user selection of an attribute of the attribute data and section data 106a, the prompt generator 120 queries the indexed RAG database 107 associated with the user-selected attribute and retrieves RAG sentence 109 associated with the user-selected attribute. In some embodiments, the retrieved RAG sentence 109 is inserted into a predefined location in the prompt (e.g., a section associated with the user-selected attribute). For instance, a RAG sentence associated with an introduction section is inserted into a predefined introduction section of the prompt.

In some embodiments, the prompt generator 120 always queries one or more RAG databases 107 for one or more RAG sentences 109. In some embodiments, the queried RAG databases 107 are randomly selected. In some embodiments, the prompt generator 120 receives an indication of which RAG database 107 to query. For example, a user using the message generation interface 126 may select a particular section or attribute to be supplemented using one or more RAG sentences 109. Such an indication of a particular RAG database 107 to query can be received as input data 106. In some embodiments, RAG sentences 109 are combined with input data 106 into an input prompt string and included in the prompt 110.

In some embodiments, the prompt generator 120 generates prompt 110 using a constrained model plan of action (cPoA). That is, prompt engineering using cPoA is executed over a number of iterations during training to determine a templatized prompt. The templatized prompt is used as prompt 110 during inference. The templatized prompt determined using cPoA is designed to instruct the model to perform a set of one or more tasks when the objective metrics are subjective (e.g., maximize diversity, minimize hallucination, increase factual faithfulness, minimize prompt-injection attacks).

In operation, cPoA leverages common information to determine a template prompt. In some embodiments, the common information includes common sections to be included in the generated suggested message content 112. For example, in the message generation domain, common information used to generate a message can include a greeting, introduction, entity information (e.g., company name, job information, company cultural information), suitability of recipient, call to action, sender information (e.g., contact information), incentives (e.g., reasons why recipient should read the message and/or consider the content of the message), and signature. Other common information can include common preferences across senders. For example, common information across senders can include a common entity associated with the sender (e.g., a company), sender preferences associated with being located in similar geographic areas, cultural similarities across groups of similar senders, sender preferences associated with senders that are the same age, and sender preferences associated with senders that are the same gender. Such common information across senders can define, for instance, constraints in the templatized prompt. As a result of identifying common information across senders and/or identifying common information to be included in generated suggested message content 112, cPoA can be used to generate the prompt 110 during prompt engineering.

The templatized prompt determined using cPoA includes predetermined portions reflective of the common information. Accordingly, such predetermined portions reflective of the identified common information can be templatized (e.g., incorporated into a template). In some embodiments, the templatized prompt determined using cPoA can include pre-summarized portions (e.g., sentences, paragraphs, logos, sections, or attributes) that are incorporated by the language model 150 into the generated suggested message content 112.

In some embodiments, the templatized prompt determined using cPoA instructs the language model 150 to generate multiple drafts of the suggested message content 112. In operation, the prompt 110 can include instructions that first instruct the language model 150 to generate suggested message content 112 using the input data 106 and further include instructions to render a condensed draft of the generated suggested message content 112 while preserving the factual correctness and input data 106 associated with the first draft of the suggested message content 112. In some embodiments, the instructions for condensing the first draft of the suggested message content 112 include a token limit constraint defined in the templatized prompt.

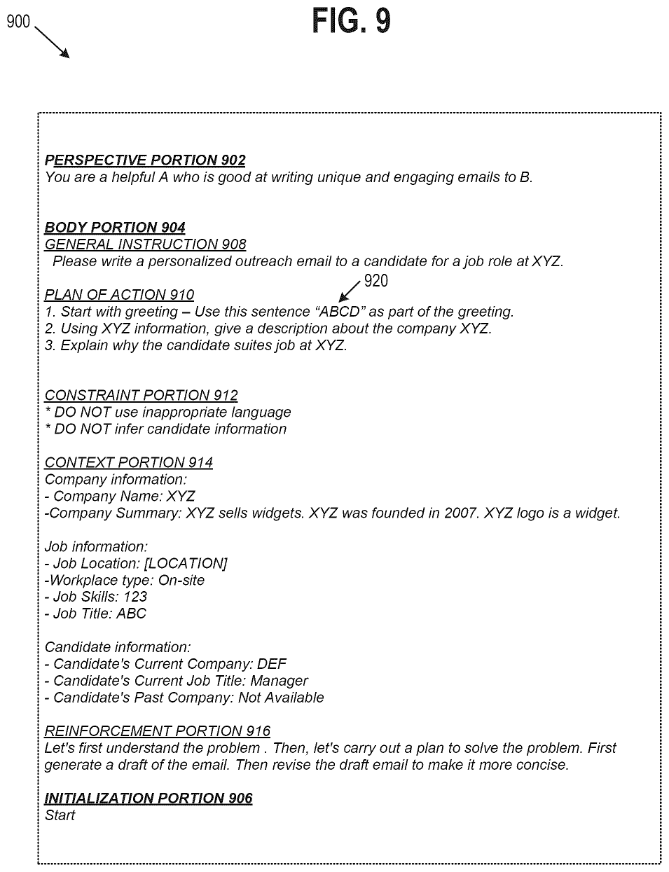

In operation, cPoA is used to determine a set of constraints that instruct the language model 150 to generate suggested message content 112 based on the input data 106. The constraints determined using cPoA increase the likelihood that the language model 150 generates suggested message content 112 that is diverse in nature and that follows length constraints. Further, cPoA mitigates hallucination and prompt injection. For example, a constraint in the templatized prompt can explicitly instruct the model not to hallucinate. An example of a templatized prompt determined using cPoA is described with reference to FIG. 9.

Unlike chain of thought reasoning, which instructs a machine learning model to explain reasoning in an output to increase the machine learning model's performance on an objective metric (e.g., accuracy), the templatized prompts determined using cPoA explicitly instruct the language model 150 what to do and how to do it, while still providing the language model 150 the flexibility to generate content. Accordingly, the templatized prompt can be used as an input to pretrained language models. That is, the templatized prompt is fine-tuned using cPoA prompt engineering such that the language model 150 receiving the templatized prompt can be domain-neutral, yet still generate suggested message content 112. In operation, the templatized prompt determined using cPoA includes predetermined guidance and structure that instructs a pretrained language model to generate suggested message content 112. In other embodiments, the language model 150 is fine-tuned using a message plan framework. The fine-tuned language model 150 learns domain-specific vocabulary, structure, and preferences using prompts including message plans to generate suggested message content 112.

The language model 150 generates personalized and diverse suggested message content using prompt 110. The generated suggested message content is informative, including greetings, entity information (e.g., company name, job information, company cultural information), sender information (e.g., contact information), and incentives (e.g., reasons why recipient should read the message and/or consider the content of the message). The generated suggested message content is also limited for brevity to increase recipient receptiveness. For example, a prompt 110 based on a templatized prompt generated using cPoA can include a constraint such as a token constraint or a character constraint.

In some embodiments, the language model 150 is a Bidirectional Auto-Regressive Transformer (BART) model, however any sequence-to-sequence machine learning model can be implemented as the language model 150. For example, the language model 150 can include an instance of a text-based encoder-decoder model that accepts a string as input and returns a single string as output. More specifically, the language model 150 can include an auto-regressive model (e.g., a sequential model which generates an output word based on the words it already generated, until it reaches a special ending word).

A layer may refer to a sub-structure of the language model 150 that includes a number of nodes (e.g., neurons) that perform a particular computation and are interconnected to nodes of adjacent layers. Nodes in each of the layers sum up values from adjacent nodes and apply an activation function, allowing the layers to detect nonlinear patterns. Nodes are interconnected by weights, which are adjusted based on an error during a training phase. The adjustment of the weights during training facilitates the language model's 150 ability to generate suggested message content 112.

The language model 150 includes one or more self-attention layers that are used to attend (e.g., assign weight values) to portions of the model input. Alternatively or in addition, the language model 150 includes one or more feed-forward layers and residual connections that allow the language model 150 to machine-learn complex data patterns including relationships between different portions of the model input in multiple different contexts.

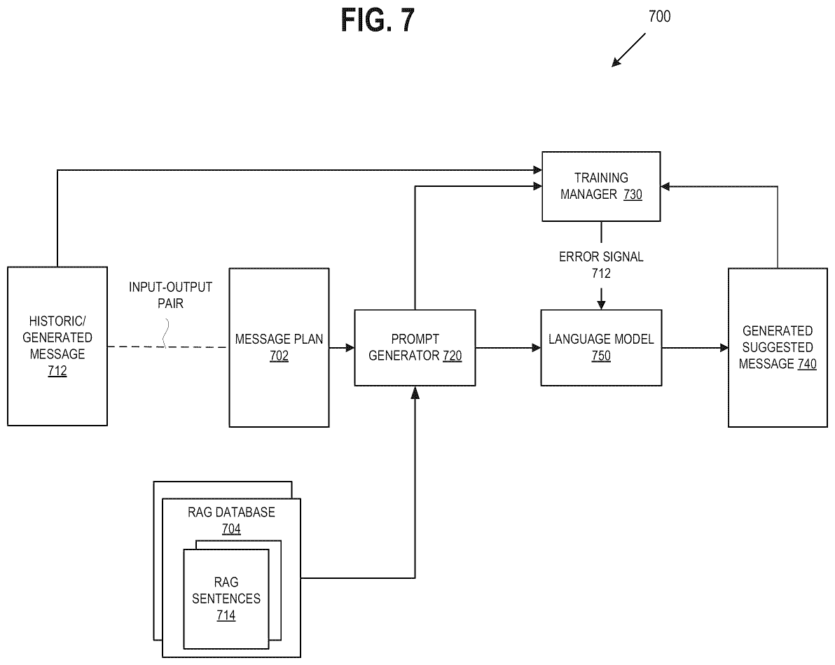

In some embodiments, the language model 150 is pretrained on domain-neutral data. In some embodiments, the language model 150 is further pretrained on domain-specific data. In some embodiments, the language model 150 is fine-tuned using domain-specific data to perform one or more domain-specific tasks (e.g., generating suggested message content 112). As described herein, the language model 150 may be a pretrained language model and receive a templatized prompt included as prompt 110. Additionally or alternatively, the language model 150 may be a fine-tuned language model and receive a message plan included as prompt 110. Fine-tuning the language model 150 using the message plan-based framework is described in more detail in FIG. 7.

The language model 150 is made accessible to message generation interface 126, e.g., as a cloud-based hosted service for model inference. The hosting environment for the language model 150 is configured to keep latency low to support online serving of message suggestions in real time.

The content evaluator 122 performs post-processing on generated suggested message content 112 before generated suggested message content 112 is displayed using the message generation interface 126. The content evaluator 122 can include automated evaluation processes and/or human review processes. For example, content evaluator 122 filters generated suggested message content 112 that includes inappropriate words or unrelated information. Alternatively or in addition, generated suggested message content 112 can be evaluated using, e.g., heuristics and/or metrics for coherence, coverage, diversity, etc. As another example, human evaluation can be used to review and filter generated suggested message content 112 for subjective aspects like hallucination and engagement. In some embodiments, operations of the content evaluator 122 are not performed and the generated suggested message content 112 is passed to the message generation interface 126.

The message generation interface 126 includes a front-end component through which the sender can interact with the generative message suggestion system 108 at the sender's electronic device. The message generation interface 126 receives verified generated suggested message content 114 from the generative message suggestion system 108 and presents the verified generated suggested message content 114 to the sender in the context of message composition for a prospective recipient. As described above, message generation interface 126 passes attribute data and section data 106a to generative message suggestion system 108 at the initiation of the sender. For example, the sender selects particular attributes to be included in a message (e.g., job title, skills, hiring company, location) via message generation interface 126 and message generation interface 126 passes the sender-selected attribute data 106a to generative message suggestion system 108, where such sender-selected data is converted into a message plan and/or applied to a templatized prompt.

The examples shown in FIG. 1 and the accompanying description, above are provided for illustration purposes. This disclosure is not limited to the described examples. Additional or alternative details and implementations are described herein.

FIG. 2 illustrates an example of a user interface, in accordance with some embodiments of the present disclosure.

The user interfaces shown in FIG. 2 is presented by an application software system, such as a user network and/or messaging system, to a user who wants to create and send a message to a prospective recipient via a network. In some implementations, the user interface is implemented as a web page that is stored, e.g., at a server or in a cache of a user device, and then loaded into a display of a user device via the user device sending a page load request to the server. The graphical user interface control elements (e.g., fields, boxes, buttons, etc.) shown in the user interface are implemented via software used to construct the user interface screen. While the user interface illustrates an example of a message generation interface screen 200, e.g., visual displays such as digital, e.g., online forms or web pages, this disclosure is not limited to online forms or web page implementations, visual displays, or graphical user interfaces. In other implementations, for instance, an automated chatbot is used in place of a fill-in form, where the chatbot requests the user to input the requested information via a conversational, natural language dialog or message-based format using text and/or spoken-language audio received via a microphone embedded in a computing device.

The message generation interface screen 200 illustrates some sender-side customization, allowing senders to select sections 204-210 and/or attributes within each section (e.g., attribute 220 within section 204, attributes 222 and 224 within section 206). In the message generation interface screen 200, the attributes are represented using pill-shaped boxes in each section 204-210.

As described herein, a section represents logical segments serving a unique purpose within a message to be generated. For instance, the section can include one or more sentences related to the unique purpose within the message. Example sections include about you, job detail, candidate profile, call to action, and company information. Such example sections are illustrated as 204-210.

In some embodiments, the sections are predetermined (e.g., by one or more users such as administrators). In some embodiments, the sections are dynamically determined. For instance, using RAG, as described herein, content (such as paragraphs and sentences) associated with dynamic sections (e.g., sections that are not predetermined) can be retrieved and incorporated into the generated suggested message content 202. For instance, the prompt generator (e.g., prompt generator 120 described in FIG. 1) queries a RAG database for a random section to be included as a dynamic section. In this manner, dynamic content can be added to the generated message content 202 to increase the likelihood of message diversity. In a non-limiting example, a sender can store content in a database. Responsive to a sender input indicating a preference that the generated suggested message content 202 include the sender-determined stored content, the sender-determined content is retrieved from the database and coherently embedded into the generated suggested message 202. In operation, the sender-determined stored content is retrieved using RAG and inserted into the prompt for use by a language model.

As described herein, an attribute is a feature or characteristic of the sender, prospective recipient, or other content (e.g., an attribute of a job opportunity). The user selection of attributes personalizes the generated suggested message content 202 with context-specific details. As described herein, attributes are represented as key:value pairs, where the key represents the attribute category (e.g., job title) and the value represents the specific attribute (e.g., Senior Engineer).

The attributes and sections are used to define the prompt. As described in FIG. 1, attribute data and section data 106a are used by the prompt generator 120 to generate a message plan prompt or populate a templatized prompt determined using cPoA.

In some embodiments, the user (e.g., a sender) can rearrange the order of sections 204-210. For instance, the sender can rearrange the order of section 208 and section 210 to modify the structure of the prompt. Modifying the structure of the prompt modifies the structure of the generated suggested message content 202. For instance, rearranging the order of section 208 and section 210 will cause the generated suggested message content 202 to describe the company info (e.g., section 210) before the candidate profile (e.g., section 208). In some embodiments, the order of the sections are randomized to increase diversity of the generated suggested message content 202. In some embodiments, the order of the sections are randomized according to one or more constraints. For instance, the first section of the prompt remains an about you section, while the order of the other sections in the prompt are randomized, diversifying the generated suggested message content 202.

In some embodiments, one or more sections and/or attributes are conditional on one or more other sections and/or attributes. For example, to enable the job detail section 206, the sender enabled the job title attribute 224.

The example shown in FIG. 2, and the accompanying description, above, are provided for illustration purposes. For example, while the examples are illustrated as user interface screens for a larger form factor such as a desktop or laptop device, the user interfaces can be configured for other forms of electronic devices, such as smart phones, tablet computers, and wearable devices. This disclosure is not limited to the described examples. Additional or alternative details and implementations are described herein.

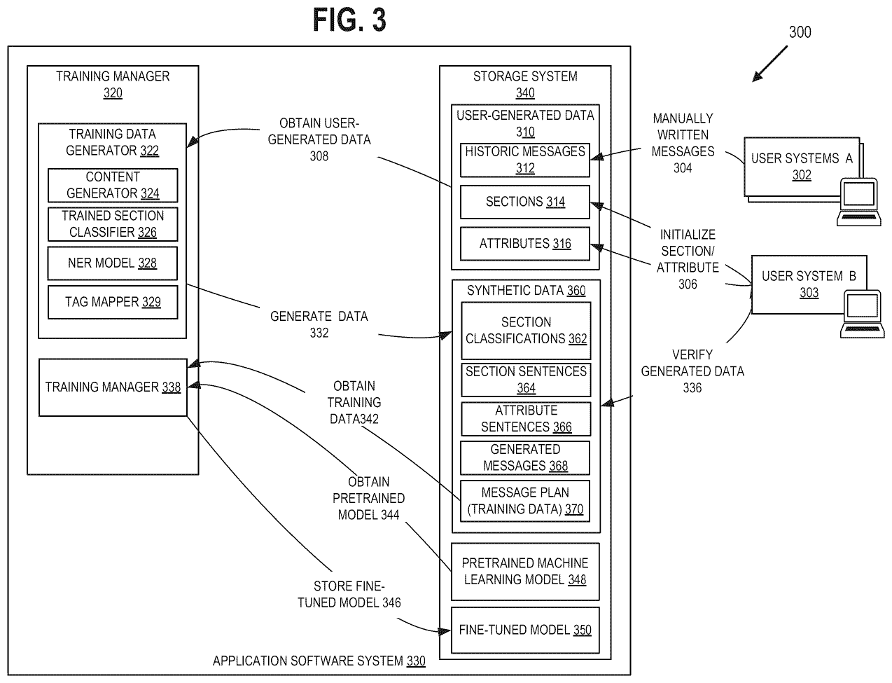

FIG. 3 is an example flow diagram of an example method for training one or more machine learning models, in accordance with some embodiments of the present disclosure.

The method is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, the method is performed by components of the training data generator 322, including, in some embodiments, components shown in FIG. 3 that may not be specifically shown in FIG. 10, or by the generative message suggestion system 1080 of FIG. 10, including, in some embodiments, components shown in FIG. 10 that may not be specifically shown in FIG. 3, or by components shown in any of the figures that may not be specifically shown in FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

In the example of FIG. 3, in the example computing system 300, an example application software system 330 is shown, which includes a training manager 320 and a storage system 340. The training manager 320 includes a training data generator 322, and a training manager 338. In the example of FIG. 3, the components of the application software system 330 are implemented using an application server or server cluster. For example, the training data generator 322 and the training manager 338 are each hosted or otherwise executed using the training manager 320. In yet other implementations, the components of the training manager 320 are executed as an application or service, executed remotely or locally.

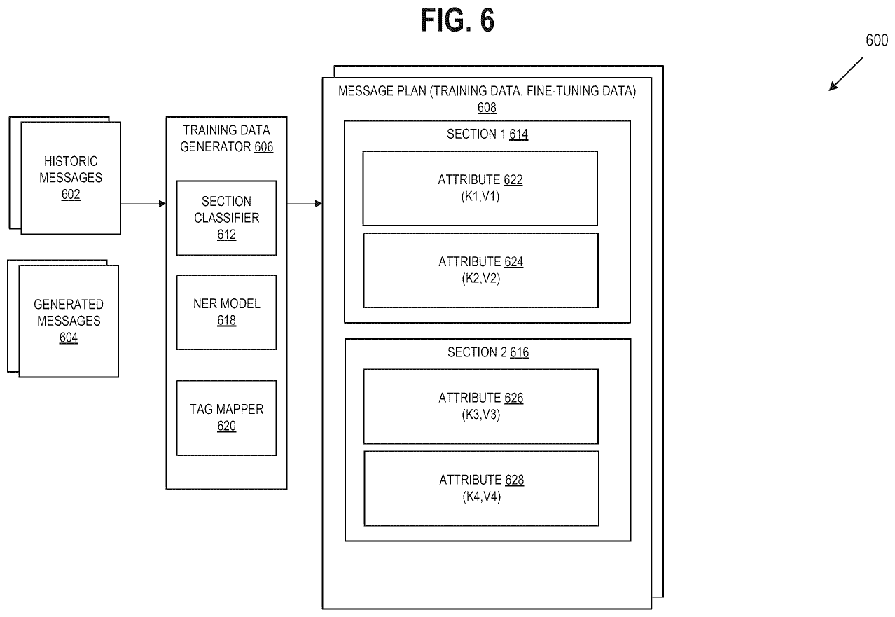

As described in more detail below, training manager 320 includes a training data generator 322 to generate synthetic data 360 used to create training data such as message plan 370. As described in more detail in FIG. 6, the message plan 370 is generated using generated messages 368 and/or historic messages 312. The training manager 338 uses the message plan 370 as training data (or fine-tuning data) to fine-tune a pretrained machine learning model 348 to obtain the fine-tuned model 350 (e.g., fine-tuned language model 150).

As shown, the storage system 340 stores user-generated data 310 received via user systems (e.g., user system A 302 and user system B 303), synthetic data 360, one or more pretrained machine learning models 348, and fine-tuned model 350.

In some embodiments, the storage system 340 stores user-generated data 310 including historic messages 312. As shown, one or more user systems 302 manually write messages 304, which can be stored as historic messages 312. The user systems 302 may be senders or other users creating message content to be replaced by, or supplemented with, generated content determined by the fine-tuned model 350. As described in more detail in FIG. 6, the historic messages are anonymized (e.g., via the Named Entity Recognition (NER) model 328) before the historic messages 312 are used as training data or shared with other components of the generative message system.

User-generated data 310 of the storage system 340 also includes section data 314 and attribute data 316. As shown, one or more user systems 303 initialize sections and attributes 306. For example, the user systems 303 can be administrative users or engineers setting predetermined sections 314 and attributes 316 to optionally be included in generated suggested message content. As described in FIG. 2, sections and attributes can be displayed to a user via message generation interface, allowing senders to select sections and attributes from predetermined sections 314 and attributes 316.

The training data generator 322 obtains user-generated data 308 such that the content generator 324, trained section classifier 326, NER model 328, and tag mapper 329 can generate data 332. As described in FIG. 6, the trained section classifier 326, NER model 328, and tag mapper 329 use synthetic data 360 (e.g., the generated messages 368) and user-generated data 310 (e.g., historic messages 312) to generate training data (e.g., message plan 370).

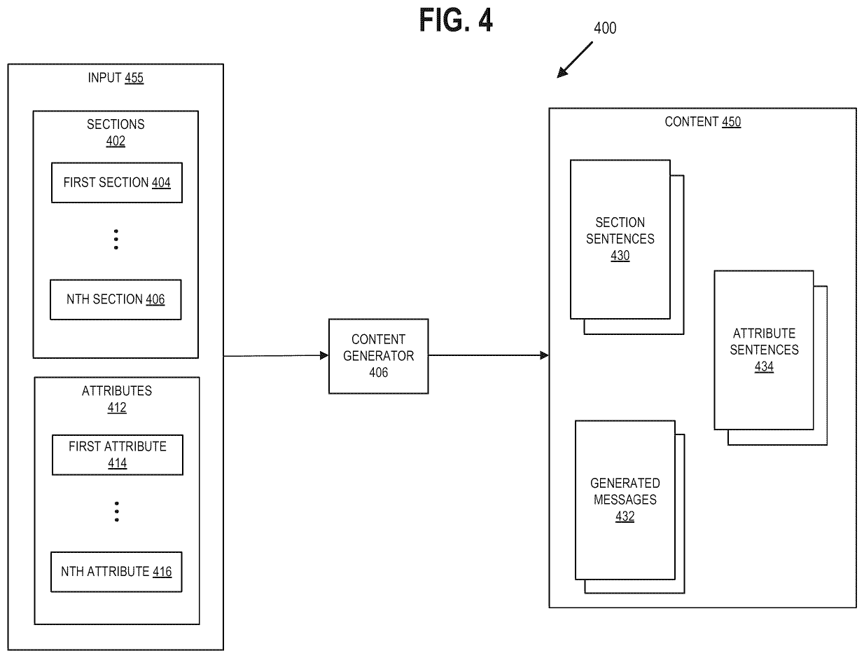

The content generator 324 can be any machine learning model trained to generate content. For example, the content generator 324 can be a generative pretraining transformer (GPT) model. As described with reference to FIG. 4, the content generator 324 synthetically generates content including section sentences 364, attribute sentences 366, and generated messages 368. The section sentences 364 are sentences associated with sections 314. Example section sentences 364 belonging to an introduction section 314 can be “Hope you are doing well,” and “Based on your experience, you are bested suited for this job.” An example section sentence 364 belonging to a job detail section 314 can include “We offer remote working flexibility.” The attribute sentences 366 are sentences associated with attributes 316. An example attribute sentence 366 associated with an Engineer job type attribute 316 can include “It is clear you have a passion for engineering; we do too!”

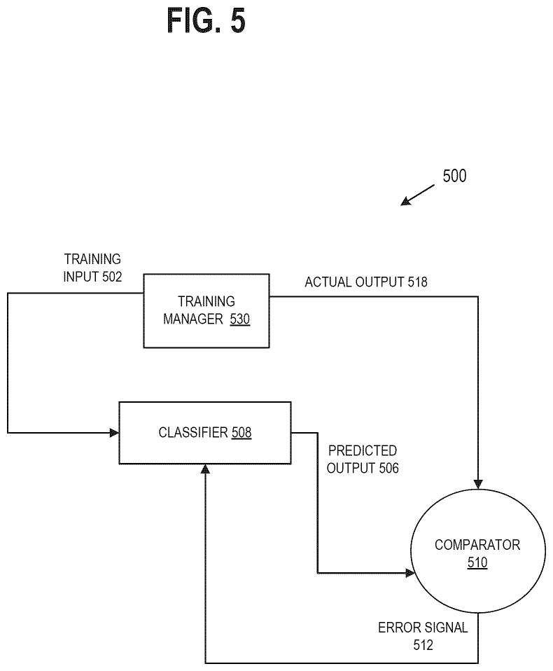

The trained section classifier 326 classifies sentences associated with sections 314. The trained section classifier 326 can be any machine learning model trained to perform multi-class classification. In some embodiments, the training manager 338 trains a classifier to perform the multi-class section classification of the trained section classifier 326. Training a classifier to become the trained section classifier 326 is described with reference to FIG. 5. In operation, a section classifier is trained using the user-generated data 310 to obtain the trained section classifier 326. The trained section classifier 326 receives generated section sentences 364 (e.g., determined by the content generator 324) and determines the associated section 314. In other words, the trained section classifier 326 identifies a section from the set of sections 314 to classify the section associated with the section sentence 364. The trained section classifier 326 is used to generate training data (e.g., message plan 370).

The NER model 328 is any machine learning model trained to perform NER (named entity recognition), a natural language processing (NLP) task. The NER model 328 is described with reference to FIG. 6. In operation, the NER model 328 redacts any Personally Identifiable Information (PII), such as names, job titles, phone numbers, and email addresses, from the historic messages 312 and delexicalizes any PII in the historic messages 312 by replacing PII with NER tags. In addition to replacing PII with tags, the NER model 328 tags content in both historic messages 312 and generated messages 368 such that the tag mapper 329 can identify attributes included in historic messages 312 and generated messages 368. As described with reference to FIG. 6, the tag mapper 329 maps the tags added to the historic messages 312 and the generated messages 368 (e.g., by the NER model 328) to attributes using heuristics. Accordingly, as described in FIG. 6, using the section classifier 326, the NER model 328, and the tag mapper 329, the training data generator 322 can generate message plans 370 (e.g., training message plans) using historic messages 312 and generated messages 368.

In some embodiments, the synthetic data 360 is verified by a user system. For example, user system B 303 (e.g., an administrator or engineer) can verify the generated data 336, including the section classifications 362, the section sentences 364, the attribute sentences 366, the generated messages 368, and/or the message plan 370.

The training manager 338 obtains training data 342 and obtains the pretrained model 344 by querying the storage system 340 for the message plan 370 and the pretrained machine learning model 348. Fine-tuning the pretrained machine learning model 348 is described with reference to FIG. 7. In some embodiments, the pretrained machine learning model 348 is a language model. As a result of fine-tuning the pretrained machine learning model 348 using the message plan 370, the pretrained machine learning model 348 becomes the fine-tuned model 350. The fine-tuned model 350 is passed to the storage system 340 for storage 346.

In some embodiments, the training manager 338 does not fine-tune the pretrained machine learning model 348. For example, the pretrained machine learning model 348 can generate suggested message content using a templatized prompt, as described with reference to FIG. 9.

The examples shown in FIG. 3 and the accompanying description above are provided for illustration purposes. This disclosure is not limited to the described examples. Additional or alternative details and implementations are described herein.

FIG. 4 is a flow diagram of an example method for generating content, in accordance with some embodiments of the present disclosure.

In example 400, the content generator 406 generates different granularities of content 450 given inputs 455 including sections 402 and attributes 412. In some embodiments, the content generator 406 is a large language model (LLM) such as GPT. As described herein, LLMs receive a prompt input, which includes a description of the task to be performed by the LLM. In some instances, the prompt is the natural language instruction of the LLM. For example, the prompt received by the content generator 406 includes one or more sections 402 and/or attributes 412, and the content generator 406 generates section sentences 430, generated messages 432, and/or attribute sentences 434, depending on the instructions of the prompt. For example, given an instruction to generate a sentence, the content generator 406 generates section sentences 430 and/or attribute sentences 434 using sections 402 and/or attributes 412. Given an instruction to generate a message (e.g., multiple structured sentences according to sections), the content generator 406 generates generated messages 432. In some embodiments, the content generator 406 generates generated messages 432 responsive to receiving a templatized prompt including sections 402 and/or attributes 412. As described herein, the templatized prompt is determined using cPoA. While generated messages 432 are described, the content generator 406 can also generate paragraphs or other content including sections 402 and attributes 412. In some embodiments, the generated messages 432 are verified by one or more users to ensure that the generated messages 432 are coherent and factually accurate (given the sections 402 and attributes 412 used to generate the generated messages 432).

In some embodiments, the sections 402 and attributes 412 are predetermined (e.g., by one or more users such as administrators, as described in FIG. 3). Example sections 402 include introduction section, job detail section, recipient experience section, and company information section. Example attributes 412 include company name, job type, recipient skills, and information about the company.

The content generator 406 generates section sentences 430 corresponding to different sections of a message. Example section sentences 430 belonging to an introduction section can be “Hope you are doing well,” and “Based on your experience, you are bested suited for this job.” An example section sentence 430 belonging to a job detail section can include “We offer remote working flexibility.”

The content generator 406 generates attribute sentences 434 based on attributes 412. An example attribute sentence associated with an Engineer job type attribute 412 can include “It is clear you have a passion for engineering; we do too!” An example attribute sentence 434 based on a common connection attribute can include “We have several common connections which may suggest you have an interest in our company.”

The content generator 406 generates messages 432 including one or more sections 402 (e.g., first section 404, Nth section 406) and one or more attributes 412 associated with the one or more sections (e.g., first attribute 414 associated with first section 404, Nth attribute 416 associated with Nth section 406). In some embodiments, the content generator 406 generates messages 432 using sections 402 and/or attributes 412 that are not present in historic messages (e.g., historic messages 312 written by users 302). For example, the sections 402 and/or attributes 412 (e.g., received as initialized sections and/or attributes such as section 314 and attributes 316 written by users 303 described in FIG. 3) can include sections 402 and/or attributes 412 that are different from the sections and/or attributes included in historic messages. As a result, the generated messages 432 can include different sections 402 and/or attributes 412 from the sections and/or attributes of historic messages. The difference in scope of sections and/or attributes in generated messages 432 and/or historic messages increases the domain-specific vocabulary learned by the language model during fine-tuning (as described with reference to FIG. 7). Additionally, the difference in scope of sections and/or attributes in generated messages 432 improves the diversity of the generated suggested message content determined using the fine-tuned language model (as described with reference to FIG. 7).

FIG. 5 is a flow diagram of an example method for training a section classifier using supervised learning, in accordance with some embodiments of the present disclosure.

Supervised learning is a method of training a machine learning model given input-output pairs. An input-output pair (e.g., training input 502 and corresponding actual output 518) is an input with an associated known output (e.g., an expected output, a labeled output, a ground truth). As described in FIG. 4, the content generator 406 generates sentences associated with sections (e.g., section sentences 430 associated with sections 402). An actual output 518 may be a section associated with a section sentence. A training input 502 is a sentence of a set of generated section sentences associated with a section.

As described herein, the training input 502 can include training data provided to the classifier 508 to train the classifier to classify sentences belonging to particular sections of content. For example, given a section 1 sentence as a training input 502, the classifier 508 learns to identify “section 1.” Similarly, given a section N sentence, the classifier 508 learns to identify “section N.”

In example 500, the training manager 530 provides, as training input 502, a sentence. The classifier 508 predicts output 506 by applying nodes in one or more layers of the classifier 508 to the training input 502. As described herein, a layer may refer to a sub-structure of the classifier 508 that include a number of nodes (e.g., neurons) that perform a particular computation and are interconnected to nodes of adjacent layers. Nodes in each of the layers sum up values from adjacent nodes and apply an activation function, allowing the layers to detect nonlinear patterns. Nodes are interconnected by weights, which are adjusted based on an error determined by comparing the actual output 518 to the predicted output 506. The adjustment of the weights during training facilitates the classifier's 508 ability to predict a reliable and/or accurate output. In some embodiments, the classifier 508 is a multi-layer perceptron (MLP). In operation, the comparator 510 compares the predicted output 506 to the actual expected (e.g., ground truth) output 518 to determine an amount of error or difference between the predicted output 506 and the actual output 518.

The error (represented by error signal 512) is determined by comparing the predicted output 506 (e.g., a predicted section associated with the sentence received as training input 502) to the actual output 518 (e.g., the actual section associated with the training input 502 sentence) using the comparator 510. The error signal 512 is used to adjust the weights in the classifier 508 such that after a set of training iterations, the classifier 508 converges, e.g., changes (or learns) over time to generate an acceptably accurate (e.g., accuracy satisfies a defined tolerance or confidence level) predicted output 506 using the input-output pairs.

The classifier 508 may be trained using a backpropagation algorithm, for instance. The backpropagation algorithm operates by propagating the error signal 512 through each of the algorithmic weights of the classifier 508 such that the algorithmic weights adapt based on the amount of error. The error signal 512 may be calculated at each iteration (e.g., each pair of training inputs 502 and associated actual outputs 518), batch, and/or epoch. The error is computed using a loss function. Non-limiting examples of loss functions may include the square error function, the room mean square error function, and/or the cross-entropy error function.

The weighting coefficients of the classifier 508 may be tuned to reduce the amount of error thereby minimizing the differences between (or otherwise converging) the predicted output 506 and the actual output 518. The classifier 508 may be trained until the error determined at the comparator 510 is within a certain threshold (or a threshold number of batches, epochs, or iterations have been reached). In this manner, the classifier 508 is trained to become section classifier (e.g., trained section classifier 326 described in FIG. 3).

In some embodiments, the classifier 508 is a LLM that receives a few-shot prompt including multiple sentences and corresponding section classifications. During training, each section name is added to the classifier 508 vocabulary as a token.

FIG. 6 is a flow diagram of an example method for generating a training message plan, in accordance with some embodiments of the present disclosure.

In example 600, the training data generator 606 extracts a message plan 608 from a message (e.g., historic message 602 or generated message 604) using the trained section classifier 612, the NER model 618, and the tag mapper 620. The message plan 608 provides both structural guidance and content-specific directives used by a language model (such as language model 150 in FIG. 1) to generate suggested message content. The message plan 608 is used as training data (or fine-tuning data) to fine-tune the language model to generate suggested message content.

Additionally, as discussed herein, the message plan 608 provides control over the personalization of the generated suggested message content. The message plan 608 includes specific information selected via user inputs (e.g., sender inputs). In operation, the message plan 608 allows for the integration of information from multiple sources based on the user inputs. For example, the message plan 608 can integrate information from recipient profile information (e.g., job experience, research areas, academic achievements, publications, contact information), entity information (e.g., company information, available job positions) and sender information (e.g., contact information, job title).

In operation, the training data generator 606 generates a message plan 608 for each received historic message 602 and/or generated message 604. In some embodiments, the training data generator 606 tags generated message plans 608 with their associated historic message 602 and/or generated message 604. Accordingly, the training data generator 606 determines input-output pairs (e.g., a historic message 602 or generated message 604 and the associated message plan 608). Such input-output pairs are leveraged as a plan-based framework to fine-tune the language model. Fine-tuning the language model is described in more detail in FIG. 7.

In some implementations, the training data generator 606 determines training data (e.g., a set of message plans 608) using one type of message (e.g., historic messages 602 or generated messages 604). In other implementations, the training data generator 606 generates training data (e.g., a set of message plans 608) using a combination of generated messages 604 and historic messages 602. Generating training data (e.g., message plan 608) using generated messages 604 (e.g., the generated messages 432 determined from the content generator 406 described in FIG. 4) allows the training data generator 606 to generate training data including sections (e.g., sections 402) and/or attributes (e.g., attributes 412) not present in historic messages 602. For example, the generated message plan 608 can include sections that a sender has not previously written about in a historic message 602. For instance, a historic message 602 can include a first section and/or a first attribute. As a result, the message plan 608 based on the historic message 602 includes the first section and/or the first attribute. A generated message 604 can include attributes and/or sections that are not present in the historic message. For instance, the generated message 604 can include a second section and/or a second attribute, where the second section and/or second attribute are different from the first section and/or first attribute. Accordingly, the message plan 608 based on the generated message 604 includes the second section and/or the second attribute.

In some embodiments, the historic messages 602 used to generate the message plan 608 are filtered. For example, the historic messages 602 used to generate message plan 608 are those historic messages 602 that have been accepted by prospective recipients. Generating message plans 608 using only accepted historic messages 602 increases the likelihood that the message plan 608 will be used to generate suggested message content that will be accepted.

To retain the confidentiality and anonymity of historic messages 602, the training data generator 606 generates message plan 608 without the use of manual annotations. Accordingly, the training data generator 606 automatically generates the message plan 608 (e.g., without human supervision) by extracting sections and attributes from historic messages 602 and generated messages 604.

In operation, for a received message (e.g., a historic message 602 or a generated message 604) the section classifier 612 identifies sentences belonging to predetermined sections of the message. As described with reference to FIG. 5, the section classifier 612 is trained to identify sections associated with sentences. In this manner, the section classifier 612 identifies the sections present in the historic messages 602 and/or generated messages 604. In example 600, the section classifier has identified section 1 614 and section 2 616 from the sentences of an input historic message 602.

As described herein, the NER model 618 is any machine learning model trained to perform NER, a NLP task. In operation, tokens of a message (e.g., either a historic message 602 or a generated message 604) are identified and categorized into predetermined categories. In some embodiments, the NER model 618 redacts PII such as names, job titles, phone numbers, and email addresses, from the historic messages 602 and delexicalizes any PII in the historic messages 602. Delexicalization includes a process of replacing PII values with corresponding semantic labels. For example, “John Adams” is replaced with [NAME]. The NER tag provides information about what entities are present in the historic messages 602 without revealing PII to ensure inferences are not made based on such information. In some implementations, the delexicalization process is only applied to PII. For instance, non-PII entity data, such as skills, are not replaced with NER tags by the NER model 618. Including the raw data values for the non-PII entity data improves the language model's (e.g., language model 150 described in FIG. 1), ability to learn correlations between the untagged data and other portions of the historic messages 602. In some embodiments, the NER model 618 tags content in both the historic messages 602 and the generated messages 604.

As described herein, an attribute is represented using key:value pairs. The tag mapper 620 determines the key:value pairs. For example, the tag (e.g., determined by the NER model 618) represents the key, and tagged content represents the value. The tag mapper 620 maps the tags added to the historic messages 602 and the generated message 604 (e.g., by the NER model 618) to attributes using heuristics. For instance, the tags output by the NER model 618 may include the generic tag [TITLE]. The tag mapper 620 maps the attribute tag [TITLE] (e.g., a key) to a value “Software Engineer.”

The tag mapper 620 determines the attributes associated with each section by disambiguating attributes. The tag mapper 620 associates attributes to sections using the section classification determined by the section classifier 612. For example, a [URL] tag can be mapped to multiple attributes (e.g., company URL, calendar URL). To map the tag to the appropriate attribute, section classification information is used. For instance, a [URL] tag in a sentence classified as belonging to an “About Company” section can be mapped by the tag mapper 620 to a [COMPANY URL] tag. Similarly, a [URL] tag in a sentence classified as belonging to a “Call to Action” section can be mapped by the tag mapper 620 to a [CALENDAR URL] tag. As a result, the message plan 608 determined using the tag mapper 620 includes context-specific attribute identification and disambiguated attributes.

Example 600 illustrates an example message plan 608 with attributes 622-628 associated with sections 614-616 of the message plan 608. The message plan 608 is an ordered sequence of training attribute data (e.g., attributes 622-628) and training section data (e.g., sections 614-616) that becomes a sequential outline of the generated suggested message content. Mathematically, the message plan 608 can be represented according to Equation (1) below:

$$P = \{ {s}_{1} : [ ( {k}_{1} , {v}_{1} ) , ( {k}_{2} , {v}_{2} ) , … ] . {s}_{2} : [ ( {k}_{3} , {v}_{3} ) , ( {k}_{4} , {v}_{4} ) , … ] , \\ … {s}_{n} : [ ( {k}_{n} , {v}_{n} ) , … ] \} \qquad ( 1 )$$

In Equation (1) above, si represents the i^{th} section of the plan and (kⱼ, vⱼ) represent the j^{th} key:value pairs associated with an attribute belonging in the corresponding section. In some embodiments, the mathematical representation of the message plan 608 is used as part of the prompt input to the machine learning model (e.g., language model 150 described in FIG. 1).

FIG. 7 is a flow diagram of an example method for training a language model using a plan-based fine-tuning framework, in accordance with some embodiments of the present disclosure.

In example 700, the training manager 730 performs supervised learning using input-output pairs to fine-tune a pretrained language model 750. For ease of description, fine-tuning the pretrained language model 750 is described herein as training the language model 750.

As described with reference to FIG. 6, a message plan 608 is extracted from a historic message 602 or a generated message 604 using the training data generator 606, where each message plan is associated with the historic message 602 or generated message 604 used to generate the message plan 608. Accordingly, message plan 702 is paired with a historic message or generated message 712. The training input is message plan 702 and the training output is the historic or generated message 712 associated with the message plan 702.

The prompt generator 720 generates a prompt using message plan 702. As described herein, the prompt generator 720 can convert a message plan including an ordered sequence of training attribute data and training section data (e.g., the sections and key:value pairs extracted from the historic message 602 and/or generated message 604 described in FIG. 6) to a prompt using one or more string transformations. For example, received attribute data (e.g., attribute data and section data 106a described in FIG. 1) can be combined with RAG sentences 714, described below, and inserted into a prompt by creating an input prompt string. In some embodiments, the prompt generator 720 randomizes the order of the input prompt strings to diversify the generated suggested message content.

The prompt generator 720 includes RAG sentences 714 stored in RAG database(s) 704 in the prompt. For example, the prompt generator 720 uses RAG to retrieve one or more RAG sentences 714 from one or more RAG databases 704. As described with reference to FIG. 4, the content generator (e.g., content generator 406) generates section sentences (e.g., section sentences 430) based on sections (e.g., sections 402) and attribute sentences (e.g., attribute sentences 434) based on attributes (e.g., attributes 412). The RAG sentences 714 can include content such as section sentences 430 based on sections 402 and attribute sentences 434 based on attributes 412 generated by the content generator and stored in one or more RAG database(s).

In some embodiments, a particular RAG database stores a particular type of RAG sentence. For example, the RAG database 704 can be indexed via section name and/or attribute key. For instance, a first RAG database 704 stores RAG sentences 714 associated with a first section, and a second RAG database 704 stores RAG sentences 714 associated with a second section. Additionally or alternatively, a first RAG database 704 stores RAG sentences 714 associated with a first attribute, and a second RAG database 704 stores RAG sentences 714 associated with a second attribute.

In some embodiments, a user can manually create RAG sentences 714 to be stored in one or more RAG databases 704. Dynamically updating the RAG databases 704 by adding, modifying, or deleting one or more RAG sentences 714 stored in the RAG database(s) 704 can have the effect of increasing the diversity of the generated message content 740. For example, increasing the RAG sentences 714 stored in one or more RAG databases 704 increases generated message content 740 diversity because the prompt generator 720 is unlikely to retrieve the same RAG sentences 714 consecutively. In some embodiments, the content generator can be re-executed to generate additional RAG sentences 714 (e.g., section sentences 430 or attribute sentences 434 generated by the content generator 406 described in FIG. 4) to be stored in one or more indexed RAG databases 704.

As shown, the prompt generator 720 retrieves one or more RAG sentences 714 from one or more RAG databases 704. The prompt generator 720 embeds the RAG sentence 714 into the prompt. For example, the prompt generator 720 prefixes the RAG sentences 714 with a token and includes the RAG sentence 714 in the generated prompt.

Training the language model 750 with RAG sentences 714 in the prompt teaches the language model 750 to coherently embed the RAG sentences 714 into the generated suggested message content 740. Instead of merely injecting the RAG sentences 714 into the generated suggested message content 740, the language model 750 learns to cohesively embed the RAG sentence 714 into the generated suggested message content 740. Additionally, the language model 750 learns to preserve factual accuracy by learning to reproduce the RAG sentences 714 in the generated suggested message content 740. As described herein, the training manager 730 can compare the RAG sentence 712 in the prompt to the RAG sentence embedded in the generated suggested message content 740 to ensure that factual accuracy is preserved.

Incorporating RAG sentences 714 into the generated suggested message content 740 increases the diversity of the generated suggested message content 740 because different instances of generated suggested message content 740 include different RAG sentences 714, which result in unique attribute sentences and/or section sentenced coherently embedded in the generated suggested message content 740. The increased diversity of generated suggested messages 740 based on RAG sentences 714 means a reduced number of historic and/or generated messages 712 can be used to train the language model 750. That is, fewer historic and/or generated messages 712 and corresponding message plans 702 are used to train the language model 750 to generate diverse generated suggested messages 740.

In addition to diversifying the generated suggested message content 740 using RAG sentences 714 from RAG databases 704, the language model 750 can incorporate flexible sampling methods into its decoding strategies to diversify the generated suggested message content 740 (e.g., so that the same or similar message suggestions are not repeatedly output). Sampling methods like nucleus sampling or top-k sampling can lead to diverse outputs for the same input because they randomly select tokens from a set of high-probability tokens generated by the language model 750 rather than always choosing the token with the highest probability. This results in multiple but different sequences for the same input, leading to diverse outputs. To balance diversity and factual correctness in these sampling methods, the sampling threshold or k-value is selected to ensure that the generated outputs are grammatically and factually correct while still allowing for some diversity in the generated text.

The language model 750 learns to transform the received prompt from the prompt generator 720 (including the message plan 702 and one or more RAG sentences 714) into generated suggested message content 740 during a training period. While described as generating messages, the language model 750 can generate any structured content using the prompt. The training manager 730 evaluates the generated suggested message 740 to determine error signal 712, which is used to adjust one or more weights interconnecting one or more nodes of the layers of the language model 750.

The training manager 730 can evaluate the generated suggested message content 740 using any NLP evaluation metric. For example, the training manager 730 can evaluate the generated suggested message content 740 by calculating a recall-oriented understudy for Gisting Evaluation (ROUGE) score. The ROUGE score is a metric for evaluating the generated suggested message content 740 with respect to the paired historic or generated message 712 associated with the message plan 702 used to generate the generated suggested message content 740. As described herein, the generated suggested message 740 also includes one or more RAG sentences 714. Accordingly, the training manager 730 evaluates the generated suggested message content 740 with respect to the historic or generated message 712 and the one or more RAG sentences 714 (received from the prompt generator 720).

Determining the error signal 712 using the ROUGE score involves calculating, by the training manager 730, a recall score and a precision score. The recall score is an indication of how much of the historic or generated message 712 and the one or more RAG sentences 714 that the generated suggested message content 740 is capturing. For example, the recall score can be a ratio of the overlapping number of tokens between the historic or generated message 712, the one or more RAG sentences 714, and the generated suggested message content 740, to the total number of tokens of the historic or generated message 712 and the one or more RAG sentences 714. The precision score is an indication of the relevance of the generated suggested message content 740 with respect to the historic or generated message 712 and the one or more RAG sentences 714. For example, the precision score can be a ratio of the overlapping number of tokens between the historic or generated message 712, the one or more RAG sentences 714, and the generated suggested message content 740, to the total number of tokens of the generated suggested message content 740. The precision score and/or the recall score can be passed to the language model 750 as error signal 712.

The error signal 712 is used to adjust the weights in the language model 750 such that after a set of training iterations, the language model 750 converges, e.g., changes (or learns) over time to generate an acceptably accurate (e.g., accuracy satisfies a defined tolerance or confidence level) generated suggested message 740. After the training period (or fine-tuning period), the language model 750 becomes a fine-tuned language model and can be stored for deployment during an inference period.

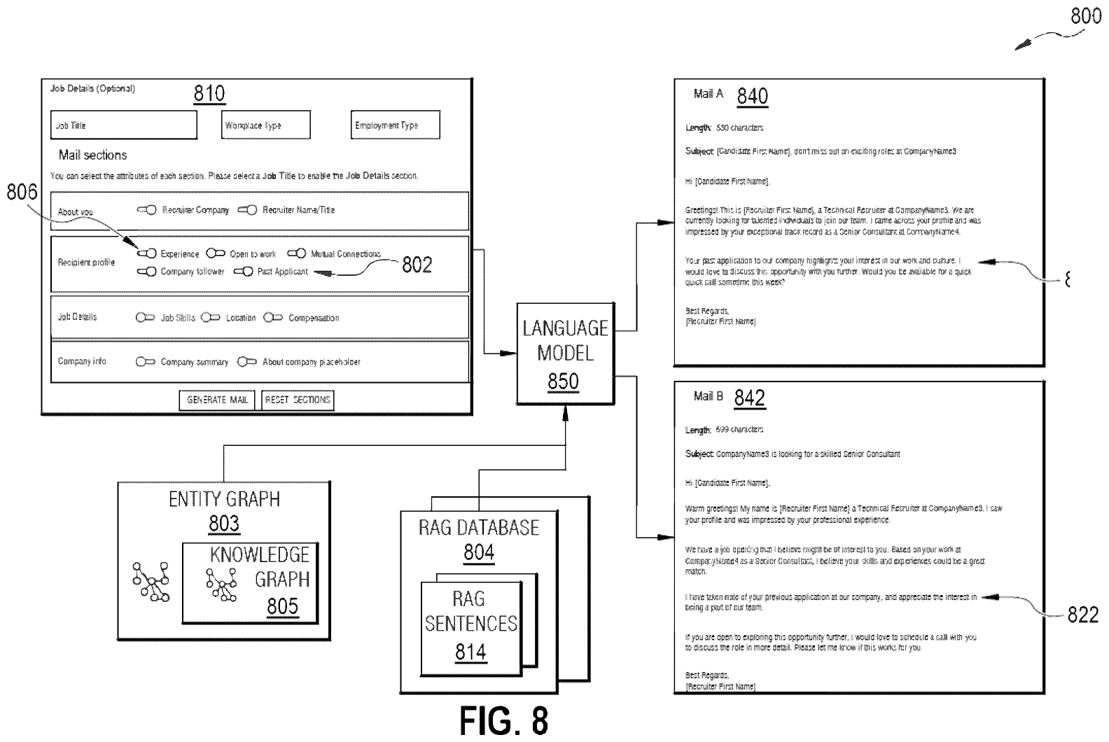

FIG. 8 is a flow diagram of an example method of the inputs and outputs of a language model, in accordance with some embodiments of the present disclosure.

The language model 850 is fine-tuned using a set of training message plans (e.g., historic messages and corresponding message plans and generated messages and corresponding message plans), where each of the training message plans include one or more attributes and sections (e.g., training attribute data and training section data). As a result, during inference, the language model 850 is configured to receive user inputs including attributes and sections. For instance, user interface 810 of example 800 illustrates an example message generation interface that allows a user (such as a sender) to select sections and corresponding attributes in each section. The selected sections and attributes are used to generate suggested message content 840 and 842. As described herein (not shown), the selected sections and attributes are converted into a message plan using one or more string transformations. Such a message plan is used as part of the prompt input into the language model 850.

As described herein, the prompt can include additional information. For example, the prompt generator (not shown) can traverse the entity graph 803 and/or the knowledge graph 805 to obtain information including sender information, prospective recipient information (including prospective recipient interests), job information, and entity information. Such information can be integrated into the message plan. For example, selecting the experience attribute 806 in the recipient profile section results in traversing the entity graph 803 and/or knowledge graph 805 for the recipient's experience. The experience, obtained from the entity graph 803 and/or knowledge graph 805 is the value of the key:value pair, the experience attribute is the key of the key value pair, and the section is the recipient profile section. The attribute data and section data are incorporated into the message plan according to the processes described herein.

In some embodiments, a tone of the generated message content 840 and 842 is identified by transversing the entity graph 803 and/or the knowledge graph 805. For example, as described in FIG. 11, a professional tone of the generated suggested message content 840 and 842 can be identified responsive to a prospective recipient being a threshold number of connections (represented as edges in the entity graph 803 and/or knowledge graph 805) away from the sender. Additionally or alternatively, a friendly tone of the generated suggested message content 840 and 842 can be identified responsive to a prospective recipient having a type of connection (e.g., “CONNECTED” edge as opposed to “FOLLOWING” edge, represented via the entity graph 803 and/or knowledge graph 805).

The prompt can further include one or more RAG sentences 814 retrieved from one or more RAG databases 804. As described herein, indexing RAG databases 804 and storing associated RAG sentences 814 in such indexed RAG databases 804 can improve the diversity of the generated suggested message content 840 and 842. For example, during inference, responsive to a user input to select a Kth attribute of a Nth section using user interface 810, the language model 850 (or the prompt generator, not shown) can retrieve a RAG sentence 814 from the RAG database 804 associated with the Kth attribute and/or retrieve a RAG sentence 814 from the RAG database 804 associated with the Nth section. Accordingly, the generated suggested message content 840 and 842 remain faithful to the user selection of the Kth attribute of the Nth section, while being diverse.

In a non-limiting example, during inference, the language model 850 generates suggested message content for N similar prospective recipients. For instance, the prospective recipients may have similar skills (e.g., coding in Python), similar work experience (e.g., at least 3 years working), and have applied to the same job in the past. As shown in example 800, the past application attribute 802 is selected. The language model 850 generates two diverse suggested message content 840 and 842. In example 800, the generated suggested message content 840 and 842 are diverse at least based on the randomly sampled RAG sentences 814 coherently embedded in the suggested message content 840 and 842. For instance, the first generated suggested message content 840 includes a first RAG sentence embedded in a first section. As shown in generated suggested message content 840, the first RAG sentence 812 says “Your past application to our company highlights your interest in our work and culture.” Similarly, the second generated suggested message content 842 includes a second RAG sentence embedded in the first section. As shown in generated suggested message content 842, the second RAG sentence 822 says “I have taken note of your previous application at our company, and appreciate the interest in being a part of our team.” Accordingly, the first and second generated suggested message content 840 and 842 include content (e.g., the first and second RAG sentences 812 and 822) that refer to the same subject matter (e.g., the past application attribute 802) with linguistically and stylistically diverse content.

FIG. 9 is an example of a model plan generated using cPoA to instruct a machine learning model to generate suggested message content, in accordance with some embodiments of the present disclosure.

As described herein, a language model uses a prompt to perform a task. In some embodiments, the prompt includes a message plan, and a fine-tuned language model (such as language model 850 described in FIG. 8) uses the prompt to generate suggested message content. In other embodiments, the prompt includes a model plan, and a domain-neutral language model (e.g., any pretrained language model such as GPT) uses the model plan to generate suggested message content.

The model plan 900 is an example of a templatized prompt generated using cPoA prompt engineering to instruct a domain-neutral language model to generate suggested message content. The model plan 900 explicitly instructs a machine learning model what to do and how to do it, while still providing the machine learning model the flexibility to generate the instructed content.

The model plan 900 includes three portions 902-906. The first portion (e.g., perspective portion 902) is a portion that defines the perspective of the language model. For example, the perspective portion 902 states that the language model is “A” with a task of performing “B.” In other embodiments, the perspective portion 902 can include a requirement that the message include context information (defined in the context portion 914) such as job location, job skills, and job title. The second portion (e.g., body portion 904) is the main body of the model plan 900. The third portion (e.g., initialization portion 906) initializes the generation of the suggested message content.

The body portion 904 of the model plan 900 includes multiple sub-portions 908-916. Just as the model plan 900 includes several predetermined portions that define the behavior of the machine learning model in (e.g., portions 902-906), the body portion 904 includes additional predetermined portions 908-916 that provide more specific instruction to the language model. As shown, the predetermined portions (e.g., portions 902-916) are included in the model plan 900, whereas the content based on the predetermined portions is left to the machine learning model to generate.

The body portion 904 includes a general instruction 908. In some embodiments, the general instruction portion 908 informs the machine learning model of the task to be performed (e.g., a general idea of what to generate, and how to generate it). As shown, the general instruction 908 portion indicates that the language model is to generate a personalized outreach email for the XYZ company without hallucinations (e.g., without making assumptions of information and/or attributing skills not included in the model plan 900 and/or retrieved using the model plan 900).

The plan of action 910 portion of the body portion 904 instructs the machine learning model how to generate the suggested message content. In some embodiments, the instructions included in the plan of action 910 portion are sequential, indicating an order in which the machine learning model is to perform the steps in the model plan 900. In some embodiments, the instructions are ordered. In other embodiments, a natural language instruction includes words such as “first” and “second” to indicate an order of instructions. In some embodiments, the plan of action 910 portion includes an instruction to retrieve one or more RAG sentence. In model plan 900, the RAG sentence 920 is shown in model plan 900, however in some embodiments, the model plan 900 includes an instruction to retrieve one or more RAG sentences from one or more RAG databases. In other embodiments, the sentences included in the plan of action 910 portion are predetermined. To increase the likelihood of diversity of the generated message, the machine learning model can randomly arrange the content in the plan of action 910 portion.

The constraint portion 912 of the body portion 904 includes a collection of requirements that restrict the content generated by the language model. In some embodiments, the constraints in the constraint portion 912 are predetermined to reduce hallucinations. The context portion 914 of the body portion 904 includes contextual information that the language model can use when generated suggested message content. For example, as shown in model plan 900, the context portion 914 includes company information, job information, and candidate information. In some embodiments, one or more generative models can generate the contextual information in the context portion 914 by retrieving entity information (e.g., company information, job information, candidate information) using RAG, for instance, and subsequently summarizing the retrieved information.

The reinforcement portion 916 reinforces the plan of action by instructing the language model to generate an approach to solving the message task using the information in the model plan 900. In model plan 900, the reinforcement portion 916 instructs the machine learning model to write the generated suggested message content and subsequently revise the generated suggested message content. In some embodiments, the reinforcement portion 916 is not included in the model plan 900.

FIG. 10 is a block diagram of a computing system that includes a generative message suggestion system in accordance with some embodiments of the present disclosure.

In the embodiment of FIG. 10, a computing system 1000 includes one or more user systems 1010, a network 1020, an application software system 1030, a generative message suggestion system 1080, a data storage system 1050, and an event logging service 1070. All or at least some components of generative message suggestion system 1080 are implemented at the user system 1010, in some implementations. For example, the message generation interface 1014 and generative message suggestion system 1080 can be implemented directly upon a single client device such that communications between message generation interface 1014 and generative message suggestion system 1080 occur on-device without the need to communicate with, e.g., one or more servers over the Internet. Dashed lines are used in FIG. 10 to indicate that all or portions of generative message suggestion system 1080 can be implemented directly on the user system 1010, e.g., the user's client device. In other words, both user system 1010 and generative message suggestion system 1080 can be implemented on the same computing device.

Components of the computing system 1000 including the generative message suggestion system 1080 are described in more detail below.

A user system 1010 includes at least one computing device, such as a personal computing device, a server, a mobile computing device, or a smart appliance, and at least one software application that the at least one computing device is capable of executing, such as an operating system or a front end of an online system. Many different user systems 1010 can be connected to network 1020 at the same time or at different times. Different user systems 1010 can contain similar components as described in connection with the illustrated user system 1010. For example, many different end users of computing system 1000 can be interacting with many different instances of application software system 1030 through their respective user systems 1010, at the same time or at different times.

User system 1010 includes a user interface 1012. User interface 1012 is installed on or accessible to user system 1010 by network 1020. Embodiments of user interface 1012 include a message generation interface 1014. Message generation interface 1014 enables sender users of application software system 1030 to create, edit, and send messages to other users, to view and process message suggestions, and to perform other interactions with application software system 1030 associated with the creation, sending, and processing of messages created and sent between or among users. The message generation interface 1014 is part of a messaging interface that enables the creation, sending, and receiving of messages, in some implementations. For example, messaging generation interface 1014 is part of a front end of a messaging system portion of application software system 1030, in some implementations.

Message generation interface 1014 can include, for example, a graphical display screen that includes graphical user interface elements such as at least one input box or other input mechanism and at least one slot. A slot as used herein refers to a space on a graphical display such as a web page or mobile device screen, into which digital content such as message suggestions and messages can be loaded for display to the user. The locations and dimensions of a particular graphical user interface element on a screen are specified using, for example, a markup language such as HTML (Hypertext Markup Language). On a typical display screen, a graphical user interface element is defined by two-dimensional coordinates. In other implementations such as virtual reality or augmented reality implementations, a slot may be defined using a three-dimensional coordinate system. Examples of user interface screens that can be included in message generation interface 1014 are shown in the user interface figures shown in the drawings and described herein.

User interface 1012 can be used to input data, create, edit, send, view, receive and process messages. In some implementations, user interface 1012 enables the user to upload, download, receive, send, or share of other types of digital content items, including posts, articles, comments, and shares, to initiate user interface events, and to view or otherwise perceive output such as data and/or digital content produced by application software system 1030, generative message suggestion system 1080, and/or message distribution service 1038. For example, user interface 1012 can include a graphical user interface (GUI), a conversational voice/speech interface, a virtual reality, augmented reality, or mixed reality interface, and/or a haptic interface. User interface 1012 includes a mechanism for logging in to application software system 1030, clicking or tapping on GUI user input control elements, and interacting with message generation interface 1014 and digital content items such as messages and machine-generated message suggestions. Examples of user interface 1012 include web browsers, command line interfaces, and mobile app front ends. User interface 1012 as used herein can include application programming interfaces (APIs).

In the example of FIG. 10, user interface 1012 includes the message generation interface 1014. Message generation interface 1014 can include a front end user interface component of generative message suggestion system 1080, application software system 1030, or a messaging component of application software system 1030. Message generation interface 1014 is shown as components of user interface 1012 for ease of discussion, but access to message generation interface 1014 can be limited to specific user systems 1010. For example, in some implementations, access to message generation interface 1014 is limited to registered users of generative message suggestion system 1080 or application software system 1030 or to users who have been designated as message senders by the generative message suggestion system 1080 or application software system 1030.

Network 1020 includes an electronic communications network. Network 1020 can be implemented on any medium or mechanism that provides for the exchange of digital data, signals, and/or instructions between the various components of computing system 1000. Examples of network 1020 include, without limitation, a Local Area Network (LAN), a Wide Area Network (WAN), an Ethernet network or the Internet, or at least one terrestrial, satellite or wireless link, or a combination of any number of different networks and/or communication links.

Application software system 1030 includes any type of application software system that provides or enables the creation, upload, and/or distribution of at least one form of digital content, including machine-generated message suggestions and messages, between or among user systems, such as user system 1010, through user interface 1012. In some implementations, portions of generative message suggestion system 1080 are components of application software system 1030. Components of application software system 1030 can include an entity graph 1032 and/or knowledge graph 1034, a user connection network 1036, and a message distribution service 1038.

In the example of FIG. 10, application software system 1030 includes an entity graph 1032 and/or a knowledge graph 1034. Entity graph 1032 and/or knowledge graph 1034 include data organized according to graph-based data structures that can be traversed via queries and/or indexes to determine relationships between entities. An example of an entity graph is shown in FIG. 11, described herein. For example, as described in more detail with reference to FIG. 11, entity graph 1032 and/or knowledge graph 1034 can be used to compute various types of affinity scores, similarity measurements, and/or statistics between, among, or relating to entities.

Entity graph 1032, 1034 includes a graph-based representation of data stored in data storage system 1050, described herein. For example, entity graph 1032, 1034 represents entities, such as users, organizations, and content items, such as posts, articles, comments, and shares, as nodes of a graph. Entity graph 1032, 1034 represents relationships, also referred to as mappings or links, between or among entities as edges, or combinations of edges, between the nodes of the graph. In some implementations, mappings between different pieces of data used by application software system 1030 are represented by one or more entity graphs. In some implementations, the edges, mappings, or links indicate online interactions or activities relating to the entities connected by the edges, mappings, or links. For example, if a prospective recipient accepts a message from a sender, an edge may be created connecting the sender entity with the recipient entity in the entity graph, where the edge may be tagged with a label such as “message accepted.”

Portions of entity graph 1032, 1034 can be automatically re-generated or updated from time to time based on changes and updates to the stored data, e.g., updates to entity data and/or activity data. Also, entity graph 1032, 1034 can refer to an entire system-wide entity graph or to only a portion of a system-wide graph. For instance, entity graph 1032, 1034 can refer to a subset of a system-wide graph, where the subset pertains to a particular user or group of users of application software system 1030.

In some implementations, knowledge graph 1034 is a subset or a superset of entity graph 1032. For example, in some implementations, knowledge graph 1034 includes multiple different entity graphs 1032 that are joined by edges. For instance, knowledge graph 1034 can join entity graphs 1032 that have been created across multiple different databases or across different software products. In some implementations, knowledge graph 1034 includes a platform that extracts and stores different concepts that can be used to establish links between data across multiple different software applications. Examples of concepts include topics, industries, and skills.

Knowledge graph 1034 includes a graph-based representation of data stored in data storage system 1050, described herein. Knowledge graph 1034 represents relationships, also referred to as links or mappings, between entities or concepts as edges, or combinations of edges, between the nodes of the graph. In some implementations, mappings between different pieces of data used by application software system 1030 or across multiple different application software systems are represented by the knowledge graph 1034.

User connection network 1036 includes, for instance, a social network service, professional social network software and/or other social graph-based applications. Message distribution service 1038 includes, for example, a messaging system, such as a peer-to-peer messaging system that enables the creation and public or non-public exchange of messages or among users of application software system 1030. Application software system 1030 can include online systems that provide social network services, general-purpose search engines, specific-purpose search engines, messaging systems, content distribution platforms, e-commerce software, enterprise software, or any combination of any of the foregoing or other types of software.

A front-end portion of application software system 1030 can operate in user system 1010, for example as a plugin or widget in a graphical user interface of a web application, mobile software application, or as a web browser executing user interface 1012. In an embodiment, a mobile app or a web browser of a user system 1010 can transmit a network communication such as an HTTP request over network 1020 in response to user input that is received through a user interface provided by the web application, mobile app, or web browser, such as user interface 1012. A server running application software system 1030 can receive the input from the web application, mobile app, or browser executing user interface 1012, perform at least one operation using the input, and return output to the user interface 1012 using a network communication such as an HTTP response, which the web application, mobile app, or browser receives and processes at the user system 1010.

The message distribution service 1038 can include a data storage service, such as a web server, which stores messages and/or message suggestions generated by generative message suggestion system 1080, and transmits messages that have been created based on message suggestions generated by generative message suggestion system 1080 from the message creators/senders to the prospective recipients using network 1020.

In some embodiments, message distribution service 1038 processes requests from, for example, application software system 1030, and distributes messages and message suggestions generated by generative message suggestion system 1080, to user systems 1010 in response to requests. A request includes, for example, a network message such as an HTTP (HyperText Transfer Protocol) request for a transfer of data from an application front end to the application's back end, or from the application's back end to the front end, or, more generally, a request for a transfer of data between two different devices or systems, such as data transfers between servers and user systems. A request is formulated, e.g., by a browser or mobile app at a user device, in connection with a user interface event such as a login, click on a graphical user interface element, or a page load. In some implementations, message distribution service 1038 is part of application software system 1030 or generative message suggestion system 1080. In other implementations, message distribution service 1038 interfaces with application software system 1030 and/or generative message suggestion system 1080, for example, via one or more application programming interfaces (APIs).

In the example of FIG. 10, the application software system 1030 includes a training data generator 1062 and a training manager 1064. In other examples, the training data generator 1062 and/or the training manager 1064 are included as part of the generative message suggestion system 1080. The training data generator 1062 generates synthetic data used to train a pretrained machine learning model to generate suggested message content. For example, the training data generator 1062 obtains user-generated data (e.g., historic messages stored in the message data store 1058) and/or predetermined attributes and sections (e.g., attributes and/or sections stored in the attribute/section data store 1054). The training data generator 1062 generates synthetic data such as attribute sentences (e.g., using attributes retrieved from the attribute/section data store 1054), section sentences (e.g., using sections retrieved from the attribute/section data store 1054), and/or generated messages (e.g., using attributes and sections retrieved from the attribute/section data store 1054). The generated attribute sections and section sentences are subsequently stored in one or more RAG data stores 1056. For example, attribute sentences can be stored in a first RAG data store, and section sentences can be stored in a second RAG data store. The generated messages are stored in the message data store 1058 and/or the training data store 1060.

The training data generator 1062 uses the generated synthetic data to generate message plans (e.g., training data or fine-tuning data). For example, the message plan can be extracted from a generated message and/or a historic message using a section classifier, trained using synthetic data determined by the training data generator 1062, a NER model, and a tag mapper, described in FIG. 6.

The training manager 1064 trains one or more machine learning models. For example, the training manager trains a classifier (e.g., the section classifier 508 described in FIG. 5) using synthetic data generated by the training data generator 1062 such as section sentences and corresponding sections. The training manager 1064 also trains (or fine-tunes) a pretrained language model using the message plans determined by the training data generator 1062 (e.g., using the historic messages and/or generated messages).

The generative message suggestion system 1080 is used to generate suggested message content using user-specific inputs (e.g., received from the message generation interface 1014). In the example of FIG. 10, the generative message suggestion system 1080 includes a prompt generator 1072, a fine-tuned machine learning model 1074, and a content evaluator 1076. The prompt generator 1072 generates a prompt for the fine-tuned machine learning model 1074 using the user-specific inputs. In operation, the prompt generator 1072 uses one or more string transformations to convert the user-specific inputs into a message plan. In some embodiments, the prompt generator traverses entity graph 1032 and/or knowledge graph 1034 for attribute data used to determine the message plan. In some embodiments, the prompt generator 1072 inserts, into the generated prompt, one or more instructions to receive RAG sentences from the RAG data store 1065 (e.g., instructions to retrieve a RAG section sentence or a RAG attribute sentence). The fine-tuned machine learning model 1074 generates suggested message content using the prompt, where the generated suggested message content is based on the user-specific inputs (e.g., attribute selections and/or section selections received as a user input). The content evaluator 1076 performs post-processing on generated suggested message content before generated suggested message content is returned to the message generation interface 1014. For example, content evaluator 1076 filters generated suggested message content that includes inappropriate words or unrelated information.

Event logging service 1070 captures and records network activity data generated during operation of application software system 1030, including user interface events generated at user systems 1010 via user interface 1012, in real time, and formulates the user interface events into a data stream that can be consumed by, for example, a stream processing system. Examples of network activity data include clicks on messages or graphical user interface control elements, the creation, editing, sending, and viewing of messages, and social action data such as likes, shares, comments. For instance, when a user of application software system 1030 via a user system 1010 clicks on a user interface element, such as a message, a link, or a user interface control element such as a view, comment, share, or uploads a file, or creates a message, loads a web page, or scrolls through a feed, etc., event logging service 1070 fires an event to capture an identifier, such as a session identifier, an event type, a date/timestamp at which the user interface event occurred, and possibly other information about the user interface event, such as the impression portal and/or the impression channel involved in the user interface event. Examples of impression portals and channels include, for example, device types, operating systems, and software platforms, e.g., web or mobile.

For instance, when a sender user creates a message based on a message suggestion generated by generative message suggestion system 1080, event logging service 1070 stores the corresponding event data in a log. Event logging service 1070 generates a data stream that includes a record of real-time event data for each user interface event that has occurred.

Data storage system 1050 includes data stores and/or data services that store digital data received, used, manipulated, and produced by application software system 1030 and/or generative message suggestion system 1080, including message suggestions, messages, message metadata, attribute data, activity data, machine learning model training data, machine learning model parameters, and machine learning model inputs and outputs, such as message plans and corresponding messages.

In the example of FIG. 10, data storage system 1050 includes a message data store 1058, a RAG data store 1056, a training data store 1060, and an attribute/section data store 1054.

The message data store 1058 stores generated messages (e.g., synthetically generated via the training data generator 1062) and/or historic messages (e.g., messages previously written by a sender). The RAG data store 1056 stores section sentences and/or attribute sentences. As described herein, the data storage system 1050 may store multiple RAG data stores 1056, each RAG data store 1056 associated with one or more sections and/or one or more attributes. A user (e.g., using the user interface 1012) can update, add, or delete RAG sentences stored in one or more RAG data stores 1056. As a result of the random retrieval of sentences from the RAG data stores 1056 and the dynamic content stored in each RAG data store 1056, the generated message content, determined by the fine-tuned machine leaning model 1074, is diverse. The training data store 1060 stores data used to generate training data such as message plans. Training data also includes data used to train the section classifier (e.g., section classifier 508 described in FIG. 5). The attribute/section data store 1054 stores predetermined attributes and sections. For example, a user inputs attributes and sections using user interface 1012.

In some embodiments, the data storage system 1050 includes multiple different types of data storage and/or a distributed data service. As used herein, data service may refer to a physical, geographic grouping of machines, a logical grouping of machines, or a single machine. For example, a data service may be a data center, a cluster, a group of clusters, or a machine. Data stores of the data storage system 1050 can be configured to store data produced by real-time and/or offline (e.g., batch) data processing. A data store configured for real-time data processing can be referred to as a real-time data store. A data store configured for offline or batch data processing can be referred to as an offline data store. Data stores can be implemented using databases, such as key:value stores, relational databases, and/or graph databases. Data can be written to and read from data stores using query technologies, e.g., SQL or NoSQL.

A key:value database, or key:value store, is a nonrelational database that organizes and stores data records as key:value pairs. The key uniquely identifies the data record, i.e., the value associated with the key. The value associated with a given key can be, e.g., a single data value, a list of data values, or another key:value pair. For example, the value associated with a key can be either the data being identified by the key or a pointer to that data. A relational database defines a data structure as a table or group of tables in which data are stored in rows and columns, where each column of the table corresponds to a data field. Relational databases use keys to create relationships between data stored in different tables, and the keys can be used to join data stored in different tables. Graph databases organize data using a graph data structure that includes a number of interconnected graph primitives. Examples of graph primitives include nodes, edges, and predicates, where a node stores data, an edge creates a relationship between two nodes, and a predicate is assigned to an edge. The predicate defines or describes the type of relationship that exists between the nodes connected by the edge.

The data storage system 1050 resides on at least one persistent and/or volatile storage device that can reside within the same local network as at least one other device of computing system 1000 and/or in a network that is remote relative to at least one other device of computing system 1000. Thus, although depicted as being included in computing system 1000, portions of data storage system 1050 can be part of computing system 1000 or accessed by computing system 1000 over a network, such as network 1020.

While not specifically shown, it should be understood that any of user system 1010, application software system 1030, generative message suggestion system 1080, data storage system 1050, and event logging service 1070 includes an interface embodied as computer programming code stored in computer memory that when executed causes a computing device to enable bidirectional communication with any other of user system 1010, application software system 1030, generative message suggestion system 1080, data storage system 1050, or event logging service 1070 using a communicative coupling mechanism. Examples of communicative coupling mechanisms include network interfaces, inter-process communication (IPC) interfaces and application program interfaces (APIs).

Each of user system 1010, application software system 1030, generative message suggestion system 1080, data storage system 1050, and event logging service 1070 is implemented using at least one computing device that is communicatively coupled to electronic communications network 1020. Any of user system 1010, application software system 1030, generative message suggestion system 1080, data storage system 1050, and event logging service 1070 can be bidirectionally communicatively coupled by network 1020. User system 1010 as well as other different user systems (not shown) can be bidirectionally communicatively coupled to application software system 1030 and/or generative message suggestion system 1080.

A typical user of user system 1010 can be an administrator or end user of application software system 1030 or generative message suggestion system 1080. User system 1010 is configured to communicate bidirectionally with any of application software system 1030, generative message suggestion system 1080, data storage system 1050, and event logging service 1070 over network 1020.

Terms such as component, system, and model as used herein refer to computer implemented structures, e.g., combinations of software and hardware such as computer programming logic, data, and/or data structures implemented in electrical circuitry, stored in memory, and/or executed by one or more hardware processors.

The features and functionality of user system 1010, application software system 1030, generative message suggestion system 1080, data storage system 1050, and event logging service 1070 are implemented using computer software, hardware, or software and hardware, and can include combinations of automated functionality, data structures, and digital data, which are represented schematically in the figures. User system 1010, application software system 1030, generative message suggestion system 1080, data storage system 1050, and event logging service 1070 are shown as separate elements in FIG. 10 for ease of discussion but, except as otherwise described, the illustration is not meant to imply that separation of these elements is required. The illustrated systems, services, and data stores (or their functionality) of each of user system 1010, application software system 1030, generative message suggestion system 1080, data storage system 1050, and event logging service 1070 can be divided over any number of physical systems, including a single physical computer system, and can communicate with each other in any appropriate manner.

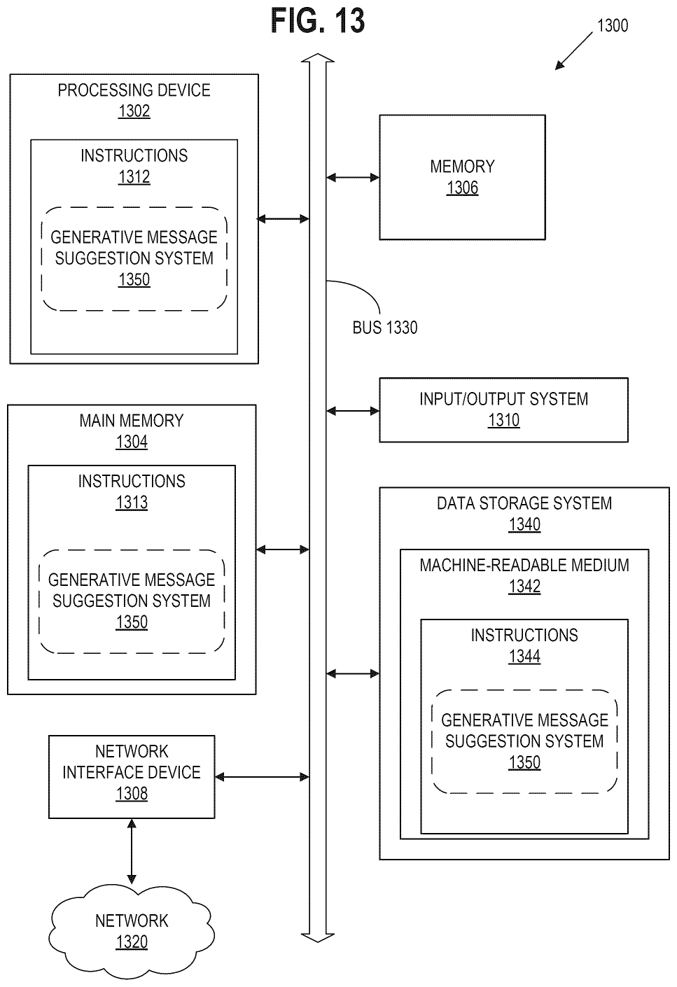

In FIG. 13, portions of message generation interface 1014, and generative message suggestion system 1080 are collectively represented as generative message suggestion system 1350 for case of discussion only. Message generation interface 1014 and generative message suggestion system 1080 are not required to be implemented all on the same computing device, in the same memory, or loaded into the same memory at the same time. For example, access to any of message generation interface 1014 and generative message suggestion system 1080 can be limited to different, mutually exclusive sets of user systems. For example, in some implementations, a separate, personalized version of generative message suggestion system 1080 (such as user-specific versions of the generator model and scoring mode), is created for each user of the generative message suggestion system 1080 such that data is not shared between or among the separate, personalized versions of the system. Additionally, while message generation interface 1014 may be implemented on user systems, generative message suggestion system 1080 may be implemented on a server computer or group of servers. Further details with regard to the operations of generative message suggestion system 1350 are described herein.

FIG. 11 is an example of an entity graph in accordance with some embodiments of the present disclosure.

The entity graph 1100 can be used by an application software system, e.g., to support a user connection network, in accordance with some embodiments of the present disclosure. The entity graph 1100 can be used (e.g., queried or traversed) to obtain or generate input data, which is used by the prompt generator (e.g., prompt generator 120 described in FIG. 1) to generate a prompt input for a machine learning model (e.g., language model 150 described in FIG. 1).

An entity graph includes nodes, edges, and data (such as labels, weights, or scores) associated with nodes and/or edges. Nodes can be weighted based on, for example, edge counts or other types of computations, and edges can be weighted based on, for example, affinities, relationships, activities, similarities, or commonalities between the nodes connected by the edges, such as common attribute values (e.g., two users have the same job title or employer, or two users are n-degree connections in a user connection network).

A graphing mechanism is used to create, update and maintain the entity graph. In some implementations, the graphing mechanism is a component of the database architecture used to implement the entity graph 1100. For instance, the graphing mechanism can be a component of data storage system 1050 and/or application software system 1030, shown in FIG. 10, and the entity graphs created by the graphing mechanism can be stored in one or more data stores of data storage system 1050.

The entity graph 1100 is dynamic (e.g., continuously updated) in that it is updated in response to occurrences of interactions between entities in an online system (e.g., a user connection network) and/or computations of new relationships between or among nodes of the graph. These updates are accomplished by real-time data ingestion and storage technologies, or by offline data extraction, computation, and storage technologies, or a combination of real-time and offline technologies. For example, the entity graph 1100 is updated in response to user updates of user profiles, user connections with other users, and user creations of new content items, such as messages, posts, articles, comments, and shares.

The entity graph 1100 includes a knowledge graph that contains cross-application links. For example, message activity data obtained from a messaging system can be linked with entities of the entity graph.

In the example of FIG. 11, entity graph 1100 includes entity nodes, which represent entities, such as content item nodes (e.g., Article 1, Article 2, Comment U1), and user nodes (e.g., User 1, User 2, User 3, User 4, User 5). Entity graph 1100 also includes characteristic nodes, which represent characteristics (e.g., profile data, topic data) of entities. Examples of characteristic nodes include title nodes (e.g., Title U1, Topic 1), company nodes (e.g., Company 1), topic nodes (Topic 1, Topic 2), and skill nodes (e.g., Skill 1).

Entity graph 1100 also includes edges. The edges individually and/or collectively represent various different types of relationships between or among the nodes. Data can be linked with both nodes and edges. For example, when stored in a data store, each node is assigned a unique node identifier and each edge is assigned a unique edge identifier. The edge identifier can be, for example, a combination of the node identifiers of the nodes connected by the edge and a timestamp that indicates the date and time at which the edge was created. For instance, in the graph 1100, edges between user nodes can represent online social connections between the users represented by the nodes, such as ‘friend’ or ‘follower’ connections between the connected nodes.

The graphic representation of nodes and edges provides information that can be used by the generative message suggestion system to generate personalized and diverse messages. For example, values associated with user-selected attributes can be obtained from traversing the graph 1100. Additionally or alternatively, traversing the nodes and edges of graph 1100 can be used to interpret interest, represented by an affinity score. For instance, a user can be interested in a topic, a user can be interested in another user employed by a company, or a user can be interested in another user that has a certain skill. In the example entity graph 1100, the user represented by the User 4 node clicked on the article represented by the Article 1 node by virtue of the CLICKED ON edge. Similarly, the user represented by the User 4 has viewed the article represented by the Article 2 node by virtue of the VIEWED edge, where both the Article 1 node and Article 2 node describe Topic 1 represented by the Topic 1 node, by virtue of the DESCRIBES edge. Accordingly, the traversal of the entity graph 1100 indicates that User 1, represented by the User 1 node, has an interest in Topic 1, represented by the Topic 1 node.

Combinations of nodes and edges can be used to compute affinity scores or other scores used by various components of the generative message suggestion system to, for example, generate message suggestions. For example, a score that measures the affinity of the user represented by the User 4 node to the Topic 1 represented by the Topic 1 node can be computed using a path p/that includes a sequence of edges between the nodes User 4 and Article 2, and/or a path p2 that includes a sequence of edges between the nodes User 4 and Comment U1 and/or a path p3 that includes a sequence of edges between the nodes User 4 and Article 1. Any one or more of the paths p1, p2, p3 and/or other paths through the graph 1100 can be used to compute scores that represent affinities, relationships, or statistical correlations between different nodes. For instance, based on relative edge counts, a user-topic affinity score computed between User 1 and Topic 1 might be higher than the user-topic affinity score computed between User 1 and Topic 2 (e.g., represented by path p4 that includes a sequence of edges between User 4, User 3, User 1, and Company 1). For instance, at least three paths p1,p2,p3 can be traversed between User 4 and Topic 1, whereas at least one path p4 can be traversed between User 4 and Topic 2, indicating a higher user-topic affinity score of Topic 1 with respect to Topic 2. Determining a user interest, representing by an affinity score, for instance, can improve the likelihood of User 4 accepting a message. For example, the generative message system can generated suggested message content including Topic 1 to increase the User 4 interest in the generated suggested message content.

Additionally, traversing the nodes and edges of a graph can be used to determine a style or tone of the generated suggested message content. For instance, in the entity graph 1100. User 1 is a first-degree connection of User 2 and User 3 by virtue of the CONNECTED edge between the User 1 node and the User 2 node, and the User 1 node and the User 3 node. User 1 is a second-degree connection of User 4, although User 1 has a different type of connection, FOLLOW, with User 4 than with User 3. Identifying the second-degree connection between User 1 and User 4 and/or identifying the different type of connection between User 1 and User 4 (as compared to the type of connection between User 1 and User 2 or User 1 and User 3) can lead to language model to generate suggested message content in a more professional tone or style, as opposed to a first-degree connection between User 1 and User 2 or User 1 and User 3 and/or type of connection (e.g., FOLLOW edge vs CONNECTED edge). For example, depending on the type of connection and/or the degree of connection, a message style can be included in the prompt. For instance, a CONNECTED connection between users maps to a friendly message style, whereas a FOLLOW connection between users maps to a professional message style. Such message styles can be indicated in the prompt using flags or other status indicators.

In the entity graph 1100, edges can represent activities involving the entities represented by the nodes connected by the edges. For example, a POSTED edge between the User 1 node and the Comment U1 node indicates that the user represented by the User 1 node posted the digital comment represented by the Comment U1 node to the application software system (e.g., as a comment involving Topic 1). Similarly, the CLICKED edge between the User 4 node and the Article 1 node indicates that the user represented by the User 4 node clicked on the article represented by the Article 1 node, and the LIKED edge between the User 4 node and the Comment U1 node indicates that the user represented by the User 4 node liked the content item represented by the Comment U1 node.

The examples shown in FIG. 11 and the accompanying description, above are provided for illustration purposes. This disclosure is not limited to the described examples.

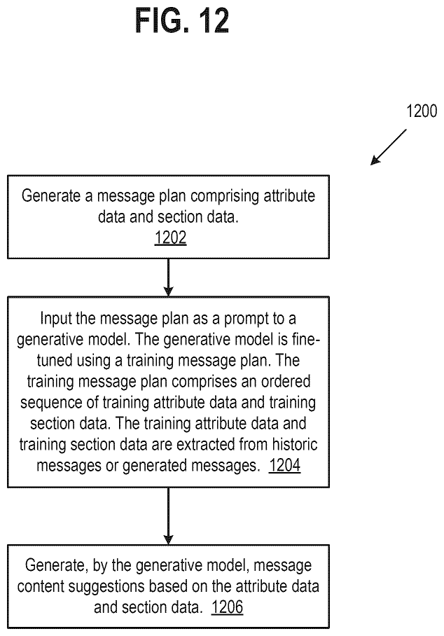

FIG. 12 is a flow diagram of an example method for fine tuning a machine learning model, in accordance with some embodiments of the present disclosure.

The method 1200 is performed by processing logic that includes hardware (e.g., processing device, circuitry, dedicated logic, programmable logic, microcode, hardware of a device, integrated circuit, etc.), software (e.g., instructions run or executed on a processing device), or a combination thereof. In some embodiments, one or more portions of method 1200 is performed by one or more components of the generative message suggestion system 1080 of FIG. 10, the generative message suggestion system 108 of FIG. 1 or the application software system 330 of FIG. 3. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, at least one process can be omitted in various embodiments. Thus, not all processes are required in every embodiment. Other process flows are possible.

At operation 1202, a processing device generates a message plan comprising attribute data and section data. The message plan provides both structural guidance (e.g., section data) and content-specific directives (e.g., attribute data) to direct a generative model to generate personalized suggested message content specific to a domain. A section represents logical segments serving a unique purpose within a message to be generated. For instance, the section can include one or more sentences related to the unique purpose within the message. Example sections include about you, job detail, candidate profile, call to action, and company information. An attribute is a feature or characteristic of the sender, prospective recipient, or other content (e.g., an attribute of a job opportunity). In some implementations, generating the message plan comprises performing one or more string transformations on the attribute data and the section data.

At operation 1204, the message plan is input as a prompt to the generative model. The generative model is fine-tuned using a training message plan. The training message plan comprises an ordered sequence of training attribute data and training section data. The training attribute data and training section data are extracted from historic messages or generated messages.

In some implementations, the training section data extracted from historic messages or generated messages is identified using a section classifier. In some implementations, the section classifier is trained to classify a sentence of a historic message or a generated message as belonging to a section.

In some implementations, the training attribute data extracted from historic messages or generated messages comprises key:value pairs. The key of the key:value pair represents the attribute category (e.g., job title) and the value of the key:value pair represents the specific attribute (e.g., Senior Engineer). They key:value pairs are disambiguated using section classifications. For example, a key:value pair extracted from a sentence can be mapped to a section using the section classification determined by the section classifier.

In some implementations, a second generative model generates generated messages using a first section or a first attribute. A set of training message plans comprise a first training message plan based on at least one of the first section or the first attribute and a second training message plan based on a historic message, where the historic message comprises a second section or a second attribute. The second section or the second attribute are different from the first section or the first attribute. The training message plan based on the generated message includes attributes that are not present in the historic message. Accordingly, the diversity of the set of training message plans can be increased by diversifying the sections and attributes of the generated messages.

At operation 1206, the generative model generates message content suggestions based on the attribute data and the section data. The generative model, fine-tuned using the message plan framework, has learned domain-specific vocabulary, structure, and other preferences to generated suggested message content that will likely be accepted by a recipient.

In some implementations, the method 1200 further comprises retrieving a sentence from a database. As described with respect to operation 1202 above, the prompt includes the message plan and the retrieved sentence. As described with reference to operation 1204 above, the prompt is input to the generative model. The generative model is trained to insert a received sentence into suggested message content. As described with respect to operation 1206 above, the message content suggestions generated by the generative model include the sentence.

FIG. 13 is a block diagram of an example computer system including a training manager component, in accordance with some embodiments of the present disclosure.

In FIG. 13, an example machine of a computer system 1300 is shown, within which a set of instructions for causing the machine to perform any of the methodologies discussed herein can be executed. In some embodiments, the computer system 1300 can correspond to a component of a networked computer system (e.g., as a component of the generative message suggestion system 108 of FIG. 1, the application software system 330 of FIG. 3, or the computer system 1000 of FIG. 10) that includes, is coupled to, or utilizes a machine to execute an operating system to perform operations corresponding to one or more components of the generative message suggestion system 108 of FIG. 1, the application software system 330 of FIG. 3, or the computer system 1000 of FIG. 10. For example, computer system 1300 corresponds to a portion of computing system 1000 when the computing system is executing a portion of the application software system 1030 or the generative message suggestion system 1080 of FIG. 10.

The machine is connected (e.g., networked) to other machines in a network, such as a local area network (LAN), an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine is a personal computer (PC), a smart phone, a tablet PC, a set-top box (STB), a Personal Digital Assistant (PDA), a cellular telephone, a web appliance, a wearable device, a server, or any machine capable of executing a set of instructions (sequential or otherwise) that specify actions to be taken by that machine. Further, while a single machine is illustrated, the term “machine” includes any collection of machines that individually or jointly execute a set (or multiple sets) of instructions to perform any of the methodologies discussed herein.

The example computer system 1300 includes a processing device 1302, a main memory 1304 (e.g., read-only memory (ROM), flash memory, dynamic random access memory (DRAM) such as synchronous DRAM (SDRAM) or Rambus DRAM (RDRAM), etc.), a memory 1303 (e.g., flash memory, static random access memory (SRAM), etc.), an input/output system 1310, and a data storage system 1340, which communicate with each other via a bus 1330.

Processing device 1302 represents at least one general-purpose processing device such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 1302 can also be at least one special-purpose processing device such as an application specific integrated circuit (ASIC), a field programmable gate array (FPGA), a digital signal processor (DSP), network processor, or the like. The processing device 1302 is configured to execute instructions 1312 for performing the operations and steps discussed herein.

In some embodiments of FIG. 13, generative message suggestion system 1350 represents portions of generative message suggestion system 1080 of FIG. 10, the application software system 1030 of FIG. 10, the application software system 330 of FIG. 3 and/or the generative message suggestion system 108 of FIG. 1 when the computer system 1300 is executing those portions of generative message suggestion system 1350. Instructions 1312 include portions of generative message suggestion system 1350 when those portions of the generative message suggestion system 1350 are being executed by processing device 1302. Thus, the generative message suggestion system 1350 is shown in dashed lines as part of instructions 1312 to illustrate that, at times, portions of the generative message suggestion system 1350 are executed by processing device 1302. For example, when at least some portion of the generative message suggestion system 1350 is embodied in instructions to cause processing device 1302 to perform the method(s) described herein, some of those instructions can be read into processing device 1302 (e.g., into an internal cache or other memory) from main memory 1304 and/or data storage system 1340. However, it is not required that all of the generative message suggestion system 1350 be included in instructions 1312 at the same time and portions of the generative message suggestion system 1350 are stored in at least one other component of computer system 1300 at other times, e.g., when at least one portion of the generative message suggestion system 1350 is not being executed by processing device 1302.

The computer system 1300 further includes a network interface device 1308 to communicate over the network 1320. Network interface device 1308 provides a two-way data communication coupling to a network. For example, network interface device 1308 can be an integrated-services digital network (ISDN) card, cable modem, satellite modem, or a modem to provide a data communication connection to a corresponding type of telephone line. As another example, network interface device 1308 can be a local area network (LAN) card to provide a data communication connection to a compatible LAN. Wireless links can also be implemented. In any such implementation network interface device 1308 can send and receive electrical, electromagnetic, or optical signals that carry digital data streams representing various types of information.

The network link can provide data communication through at least one network to other data devices. For example, a network link can provide a connection to the world-wide packet data communication network commonly referred to as the “Internet,” for example through a local network to a host computer or to data equipment operated by an Internet Service Provider (ISP). Local networks and the Internet use electrical, electromagnetic, or optical signals that carry digital data to and from computer system computer system 1300.

Computer system 1300 can send messages and receive data, including program code, through the network(s) and network interface device 1308. In the Internet example, a server can transmit a requested code for an application program through the Internet and network interface device 1308. The received code can be executed by processing device 1302 as it is received, and/or stored in data storage system 1340, or other non-volatile storage for later execution.

The input/output system 1310 includes an output device, such as a display, for example a liquid crystal display (LCD) or a touchscreen display, for displaying information to a computer user, or a speaker, a haptic device, or another form of output device. The input/output system 1310 can include an input device, for example, alphanumeric keys and other keys configured for communicating information and command selections to processing device 1302. An input device can, alternatively or in addition, include a cursor control, such as a mouse, a trackball, or cursor direction keys for communicating direction information and command selections to processing device 1302 and for controlling cursor movement on a display. An input device can, alternatively or in addition, include a microphone, a sensor, or an array of sensors, for communicating sensed information to processing device 1302. Sensed information can include voice commands, audio signals, geographic location information, haptic information, and/or digital imagery, for example.

The data storage system 1340 includes a machine-readable storage medium 1342 (also known as a computer-readable medium) on which is stored at least one set of instructions 1344 or software embodying any of the methodologies or functions described herein. The instructions 1344 can also reside, completely or at least partially, within the main memory 1304 and/or within the processing device 1302 during execution thereof by the computer system 1300, the main memory 1304 and the processing device 1302 also constituting machine-readable storage media. In one embodiment, the instructions 1344 include instructions to implement functionality corresponding to generative message suggestion system 1350 (e.g., generative message suggestion system 1080 of FIG. 10, the application software system 1030 of FIG. 10, the application software system 330 of FIG. 3 and/or the generative message suggestion system 108 of FIG. 1).

Dashed lines are used in FIG. 13 to indicate that it is not required that the generative message suggestion system 1350 be embodied entirely in instructions 1312, 1314, and 1344 at the same time. In one example, portions of the generative message suggestion system 1350 are embodied in instructions 1314, which are read into main memory 1304 as instructions 1314, and portions of instructions 1312 are read into processing device 1302 as instructions 1312 for execution. In another example, some portions of the generative message suggestion system 1350 are embodied in instructions 1344 while other portions are embodied in instructions 1314 and still other portions are embodied in instructions 1312.

While the machine-readable storage medium 1342 is shown in an example embodiment to be a single medium, the term “machine-readable storage medium” should be taken to include a single medium or multiple media that store the instructions. The term “machine-readable storage medium” shall also be taken to include any medium that is capable of storing or encoding a set of instructions for execution by the machine and that cause the machine to perform any of the methodologies of the present disclosure. The term “machine-readable storage medium” shall accordingly be taken to include, but not be limited to, solid-state memories, optical media, and magnetic media. The examples shown in FIG. 13 and the accompanying description above are provided for illustration purposes. This disclosure is not limited to the described examples.

Some portions of the preceding detailed description have been presented in terms of algorithms and symbolic representations of operations on data bits within a computer memory. These algorithmic descriptions and representations are the ways used by those skilled in the data processing arts to convey the substance of their work most effectively to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, which manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the computing system 100 or the computing system 1000, can carry out the above-described computer-implemented methods in response to its processor executing a computer program (e.g., a sequence of instructions) contained in a memory or other non-transitory machine-readable storage medium (e.g., a non-transitory computer readable medium). Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, which can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

The techniques described herein may be implemented with privacy safeguards to protect user privacy. Furthermore, the techniques described herein may be implemented with user privacy safeguards to prevent unauthorized access to personal data and confidential data. The training of the AI models described herein is executed to benefit all users fairly, without causing or amplifying unfair bias.

According to some embodiments, the techniques for the models described herein do not make inferences or predictions about individuals unless requested to do so through an input. According to some embodiments, the models described herein do not learn from and are not trained on user data without user authorization. In instances where user data is permitted and authorized for use in AI features and tools, it is done in compliance with a user's visibility settings, privacy choices, user agreement and descriptions, and the applicable law. According to the techniques described herein, users may have full control over the visibility of their content and who sees their content, as is controlled via the visibility settings. According to the techniques described herein, users may have full control over the level of their personal data that is shared and distributed between different AI platforms that provide different functionalities. According to the techniques described herein, users may have full control over the level of access to their personal data that is shared with other parties. According to the techniques described herein, personal data provided by users may be processed to determine prompts when using a generative AI feature at the request of the user, but not to train generative AI models. In some embodiments, users may provide feedback while using the techniques described herein, which may be used to improve or modify the platform and products. In some embodiments, any personal data associated with a user, such as personal information provided by the user to the platform, may be deleted from storage upon user request. In some embodiments, personal information associated with a user may be permanently deleted from storage when a user deletes their account from the platform.

According to the techniques described herein, personal data may be removed from any training dataset that is used to train AI models. The techniques described herein may utilize tools for anonymizing member and customer data. For example, user's personal data may be redacted and minimized in training datasets for training AI models through delexicalisation tools and other privacy enhancing tools for safeguarding user data. The techniques described herein may minimize use of any personal data in training AI models, including removing and replacing personal data. According to the techniques described herein, notices may be communicated to users to inform how their data is being used and users are provided controls to opt-out from their data being used for training AI models.

According to some embodiments, tools are used with the techniques described herein to identify and mitigate risks associated with AI in all products and AI systems. In some embodiments, notices may be provided to users when AI tools are being used to provide features.

While the invention has been described in terms of several embodiments, those skilled in the art will recognize that the invention is not limited to the embodiments described, can be practiced with modification and alteration within the spirit and scope of the appended claims. The description is thus to be regarded as illustrative instead of limiting.

What is claimed is:

1. A method comprising:
generating a message plan comprising attribute data and section data;
inputting the message plan as a prompt to a first generative model, wherein the first generative model is fine-tuned using a training message plan, wherein the training message plan comprises an ordered sequence of training attribute data and training section data, wherein the training attribute data and training section data are extracted from at least one or more historic messages or generated messages; and
generating, by the first generative model, one or more message content suggestions based on the attribute data and section data.

2. The method of claim 1, further comprising:
retrieving a sentence from a database;
generating the prompt including the sentence;
inputting the prompt to the first generative model, wherein the first generative model is trained to insert a received sentence into suggested message content; and
generating, by the first generative model, the one or more message content suggestions, wherein the one or more message content suggestions comprise the sentence.

3. The method of claim 1, wherein the training section data extracted from at least one or more historic messages or generated messages is identified using a section classifier.

4. The method of claim 3, wherein the section classifier is trained to classify a sentence of a historic message of the one or more historic messages or a generated message of the one or more generated messages as belonging to a section.

5. The method of claim 1, wherein the training attribute data extracted from at least one or more historic messages or generated messages comprises key:value pairs.

6. The method of claim 1, wherein generating the message plan comprises performing one or more string transformations on the attribute data and the section data.

7. The method of claim 1, further comprising:
generating, using a second generative model, a generated message comprising a first section or a first attribute; and
determining a set of training message plans comprising a first training message plan based on at least one of the first section or the first attribute and a second training message plan based on a historic message, wherein the historic message comprises a second section or a second attribute, and the second section or the second attribute are different from the first section or the first attribute.

8. A system comprising:
at least one processor; and
at least one memory device coupled to the at least one processor, wherein the at least one memory device comprises instructions that, when executed by the at least one processor, cause the at least one processor to perform at least one operation comprising:
generating a message plan comprising attribute data and section data;
inputting the message plan as a prompt to a first generative model, wherein the first generative model is fine-tuned using a training message plan, wherein the training message plan comprises an ordered sequence of training attribute data and training section data, wherein the training attribute data and training section data are extracted from at least one or more historic messages or generated messages; and
generating, by the first generative model, one or more message content suggestions based on the attribute data and section data.

9. The system of claim 8, wherein the instructions, when executed by the at least one processor, cause the at least one processor to perform at least one operation further comprising:
retrieving a sentence from a database;
generating the prompt including the sentence;
inputting the prompt to the first generative model, wherein the first generative model is trained to insert a received sentence into suggested message content; and
generating, by the first generative model, the one or more message content suggestions, wherein the one or more message content suggestions comprise the sentence.

10. The system of claim 8, wherein the training section data extracted from at least one or more historic messages or generated messages is identified using a section classifier.

11. The system of claim 10, wherein the section classifier is trained to classify a sentence of a historic message of the one or more historic messages or a generated message of the one or more generated messages as belonging to a section.

12. The system of claim 8, wherein the training attribute data extracted from at least one or more historic messages or generated messages comprises key:value pairs.

13. The system of claim 8, wherein generating the message plan comprises performing one or more string transformations on the attribute data and the section data.

14. The system of claim 8, wherein the instructions, when executed by the at least one processor, cause the at least one processor to perform at least one operation further comprising:
retrieving a sentence from a database;
generating the message plan including the sentence;
inputting the message plan as the prompt to the first generative model, wherein the first generative model is trained to insert a received sentence into suggested message content; and
generating, by the first generative model, the one or more message content suggestions, wherein the one or more message content suggestions comprise the sentence.

15. A non-transitory machine-readable storage medium comprising instructions that, when executed by at least one processor, cause the at least one processor to perform at least one operation comprising:
generating a message plan comprising attribute data and section data;
inputting the message plan as a prompt to a first generative model, wherein the first generative model is fine-tuned using a training message plan, wherein the training message plan comprises an ordered sequence of training attribute data and training section data, wherein the training attribute data and training section data are extracted from at least one or more historic messages or generated messages; and
generating, by the first generative model, one or more message content suggestions based on the attribute data and section data.

16. The non-transitory machine-readable storage medium of claim 15, wherein the instructions, when executed by the at least one processor, cause the at least one processor to perform at least one operation further comprising:
retrieving a sentence from a database;
generating the prompt including the sentence;
inputting the prompt to the first generative model, wherein the first generative model is trained to insert a received sentence into suggested message content; and
generating, by the first generative model, the one or more message content suggestions, wherein the one or more message content suggestions comprise the sentence.

17. The non-transitory machine-readable storage medium of claim 15, wherein the training section data extracted from at least one or more historic messages or generated messages is identified using a section classifier.

18. The non-transitory machine-readable storage medium of claim 17, wherein the section classifier is trained to classify a sentence of a historic message of the one or more historic messages or a generated message of the one or more generated messages as belonging to a section.

19. The non-transitory machine-readable storage medium of claim 15, wherein the training attribute data extracted from at least one or more historic messages or generated messages comprises key:value pairs.

20. The non-transitory machine-readable storage medium of claim 15, wherein generating the message plan comprises performing one or more string transformations on the attribute data and the section data.
